(19) United States
(12) Patent Application Publication
(10) Pub. No.: US 2014/0344716 A1
(43) Pub. Date: Nov. 20, 2014

(54) Cluster-Based Social Networking System and Method

(71) Applicant: Foster, LLC, Davie, FL (US)

(72) Inventors: Christopher Martin, Davie, FL (US); Hudson Duan, Albany, NY (US); Cameron Setzer, Durham, NC (US); Christopher Walker, Stafford, VA (US)

(73) Assignee: Foster, LLC, Davie, FL (US)

(21) Appl. No.: 13/893,766

(22) Filed: May 14, 2013

(51) Int. Cl. H04L 29/08

(52) U.S. Cl. CPC H04L 67/10
USPC 715/753

(57) ABSTRACT

A networking system operable on a computerized device, such as a mobile device, with a processor and memory is provided to allow users to share location data and communicate with other users. Users are classifiable as friends, groups, lists, and/or clusters to facilitate data sharing. Data may be displayed on a map. The interface may be classified into panels, each panel including screens. Panels may include a friends panel, clusters panel, happenings panel relating to deals and events, and a communications panel.

### FIELD OF THE INVENTION

The invention relates to a networking system. More particularly, the invention relates to a system facilitating communication among a cluster of users through a location-aware social networking system.

### BACKGROUND

The internet has become an essential component in the lives of many people. As a result, users of the internet have become continually more connected. The internet started by allowing users to communicate with one another using a computer, via protocols such as email and Usenet. Through these channels, internet users were provided with new tools to communicate with one another, which could be used in conjunction with telephone calls, physical mail, and in-person meetings.

The World Wide Web increased the possibilities of communicating over a globally connected network. Through the World Wide Web, users could access websites using a web browser and view information relating to companies and people of interest. These interests may include restaurants, activities, and local establishments. As the internet continued to develop, web browsers began including advanced features that allowed for more sophisticated interactions between users. As the internet expanded, and technology advanced, smartphones and mobile devices have become common tools to access the global network.

Social networks provided another communicative avenue, linking users to their friends and acquaintances. Social networks initially provided a directory of user information, which could be updated in real time. As social networks gained popularity, many companies and providers created numerous discrete social networks, all of which provided a different function and experience. However, with so many social networks, a user is often faced with having to select between investing a significant amount of time to manage multiple social networks, or having his or her needs unfulfilled.

What is needed is a networking system that provides information about businesses that is socially connected to groups of people. What is also needed is a networking system that can allow users to associate with one another in clusters to communicate and share information relating to happenings. What is also needed is a networking system to alert a user of the location and activity of a friend or other user, and provide an interface to communicate with the same.

### SUMMARY

A networking system is provided to facilitate data sharing and communication among users. The system is operable on a computerized device, such as a mobile device, with a processor and memory. The system may allow users to share location data with other users. Users are classifiable as friends, groups, lists, and/or clusters to facilitate data sharing. Data may be displayed on a map. The interface may be classified into panels, each panel including screens. Panels may include a friends panel, clusters panel, happenings panel relating to deals and events, and a communications panel.

According to embodiments of the present invention, a networking system is described that may provide information about businesses, the system being socially connected to groups of people. The networking system is provided that also may allow users to associate with one another in clusters to communicate and share information relating to happenings. Additionally, a networking system is provided to alert a user of the location and activity of a friend or other user, and provide an interface to communicate with the same.

In one aspect, according to an embodiment of the present invention, a networking system is provided that is operable on a computerized device with a processor and memory. The networking system may include an interface to display information and receive data, the data being storable in a database Panels may be included in the interface that are usable to access screens, the panels relating to the data accessible by the included screens. A map may be included to display at least part of the data with relation to a geographic location. A location module may be provided to determine a present geographic location, the present geographic location being usable to affect a location displayed on the map and the data provided through the panels. Data may be receivable and transmittable with additional computerized devices over a network using a network controller. Receipt and transmission of data is conformable to occur within a cluster of users. An interaction between users is includable in the data.

In another aspect, the computerized device may be a mobile device with a touchscreen, the system being at least partially controllable using the touchscreen.

In another aspect, the computerized device may include an accelerometer to measure force about at least one axis of motion, the system being at least partially controllable using the force or motion.

In another aspect, the computerized device may include a gyroscope, the system being at least partially controllable using the gyroscope. The map may be displayed on the interface from any panel when the device is rotated as detected by the gyroscope.

In another aspect, the touchscreen may be used to input a command by positioning a detectible object adjacent to an area of the touchscreen displaying interface that relates to the command.

In another aspect, hot corner commands may be accessible from at least part of the interface by positioning the detectable object adjacent to a corner of the interface.

In another aspect, the location may be determinable using GPS, WiFi, or cellular networks.

In another aspect, the panels may include screens grouped for a related function, the panels including at least a first, second, third, and fourth panel. The first panel may include the screens for accessing and using the data relating to friends, the friends being associable with the user through the first panel. The second panel may include the screens for accessing and using the data relating to the clusters, the clusters being definable, viewable, and joinable by the user through the second panel. The third panel may include the screens for accessing and using deals and events, the events being definable, viewable, and joinable through the third panel. The fourth panel may include screens for communicating with friends, members of clusters, and other users.

In another aspect, the deals are creatable by users with business profiles, the deals being fundable using points.

In another embodiment of the present invention, in one aspect, a networking system is provided that is operable on a mobile computerized device with a processor and memory. The system may include an interface to display information and receive data. The system may also have panels included in the interface relating to the data that is accessible and usable. A map may be included to display at least part of the data with relation to a geographic location. A location module may be included to determine a present geographic location, the present geographic location being usable to affect a location displayed on the map and the data provided through the panels. Data is receivable and transmittable with additional computerized devices over a network using a network controller. Receipt and transmission of data is conformable to occur within a cluster of users, wherein an interaction between users is includable in the data. The mobile computerized device may include a touchscreen. The system may be at least partially controllable using the touchscreen by positioning a detectible object adjacent to an area of the touchscreen, which may be displaying the interface, that relates to a command. The mobile computerized device may also include an accelerometer to measure force about at least one axis of motion, the system being at least partially controllable using the force measured by the accelerometer. Additionally, the mobile computerized system may include a gyroscope to measure rotation, the system being at least partially controllable using the rotation measured by the gyroscope. A map may be displayed on the interface from any panel when the device is rotated as detected by the gyroscope.

In another aspect, the data accessible from the panels may be presented using screens, the screens being accessible through the panel and usable to access or modify that data. The data may also be storable on a database.

In another aspect, hot corner commands may be accessible from the interface by positioning the detectable object adjacent to a corner of the interface.

In another aspect, the location is determinable using GPS, WiFi, or cellular networks.

In another aspect, the panels may include screens grouped for a related function, the panels including at least a first, second, third, and fourth panel. The first panel may include the screens for accessing and using the data relating to friends, the friends being associable with the user through the first panel. The second panel may include the screens for accessing and using the data relating to clusters, the clusters being definable, viewable, and joinable by the user through the second panel. The third panel may include the screens for accessing and using deals and events, the events being definable, viewable, and joinable through the third panel. The fourth panel may include screens for communicating with friends, members of clusters, and other users.

In another aspect, the deals may be created by users with business profiles, the deals being fundable using points.

According to an embodiment of the present invention, a method aspect is provided for operating a networking system using a computerized device with a processor and memory. The system may include an interface, panels accessible from the interface, screens accessible from the panels, a map, and a location module. The method aspect includes using the interface to display information and receive data, the data being storable in a database. The method also includes providing the panels and screens. The data may be accessed and used through the screens. The method also includes providing the map to display at least part of the data with relation to a geographic location. Additionally, the method includes using the location module to determine a present geographic location to affect a location that is displayed on the map and the data provided through the panels. The method also includes receiving and transmitting data with additional computerized devices over a network using a network controller. Receipt and transmission of data is conformable to occur within a cluster of users. Additionally, interaction between users is includable in the data.

In another aspect, the computerized device may be a mobile device with a touchscreen. In this aspect, the method may further include receiving inputs from the touchscreen to at least partially control the system.

In another aspect, the computerized device may further include an accelerometer to measure force about at least one axis of motion. In this aspect, the method may further include at least partially controlling the system using the forces.

In another aspect, the computerized device includes a gyroscope. In this aspect, the method may further include at least partially controlling the system using the gyroscope.

In another aspect, the method may further include displaying the map on the interface from any panel when the device is rotated as detected by the gyroscope.

In another aspect, the touchscreen may be used to input a command by positioning a detectible object adjacent to an area of the touchscreen displaying interface that relates to the command.

In another aspect, hot corner commands may be accessible from the interface by positioning the detectable object adjacent to a corner of the interface.

In another aspect, the method may further include determining the location using GPS, WiFi, or cellular networks.

In another aspect, the method may further include grouping the panels for a related function. The panels may include a first, second, third, and fourth panel. The first panel may include the screens for accessing and using the data relating to friends, the first being associable with the user through the friends panel. The second panel may include the screens for accessing and using the data relating to clusters, the clusters being definable, viewable, and joinable by the user through the second panel. The third panel may include the screens for accessing and using deals and events, the events being definable, viewable, and joinable through the third panel. The fourth panel to include screens for communicating with friends, members of clusters, and other users.

In another aspect, deals may be created by users with business profiles, the deals being fundable using points.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is an illustrative view of the interface, showing a home screen, according to an embodiment of the present invention.

FIG. 2 is a block diagram of a computerized system, according to an embodiment of the present invention.

FIG. 3 is an illustrative view of the interface in the landscape orientation, displaying a map screen, according to an embodiment of the present invention.

FIG. 4 is a diagram illustrating rotation of a computerized device, according to an embodiment of the present invention.

FIG. 5 is a flowchart illustrating an operation to detect the orientation of a computerized device, according to an embodiment of the present invention.

FIG. 6 is a block diagram illustrating a model structure of the system, according to an embodiment of the present invention.

FIG. 7 is a diagram illustrating hot corners, according to an embodiment of the present invention.

FIG. 8 is a flowchart illustrating a model login and registration operation, according to an embodiment of the present invention.

FIG. 9 is a diagram illustrating a login screen, according to an embodiment of the present invention.

FIG. 10 is a diagram illustration a registration screen, according to an embodiment of the present invention.

FIG. 11 is a diagram illustrating a notification bar in a minimized position, according to an embodiment of the present invention.

FIG. 12 is a diagram illustrating the notification bar of FIG. 11 being moved into a displayed position, according to an embodiment of the present invention.

FIGS. 13-14 are diagrams illustrating screens of the friends panel, according to an embodiment of the present invention.

FIG. 15 is a flowchart illustrating a model search operation, according to an embodiment of the present invention.

FIGS. 16-17 are diagrams illustrating screens of the friends panel, according to an embodiment of the present invention.

FIG. 18 is a diagram illustrating a screen of the happenings panel, according to an embodiment of the present invention.

FIG. 19 is a diagram illustrating a screen of the clusters panel, according to an embodiment of the present invention.

FIG. 20 is a diagram illustrating a screen of the communications panel, according to an embodiment of the present invention.

FIG. 21 is a diagram illustrating a “Settings” screen, according to an embodiment of the present invention.

FIG. 22 is a flowchart of a buying chain, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a cluster-based social networking system and method will be discussed. Those of skill in the art will appreciate alternative labeling of the cluster-based social networking system as a networking system, system, application, app, the invention, or other similar names. Skilled readers should not view the inclusion of any alternative labels as limiting in any way.

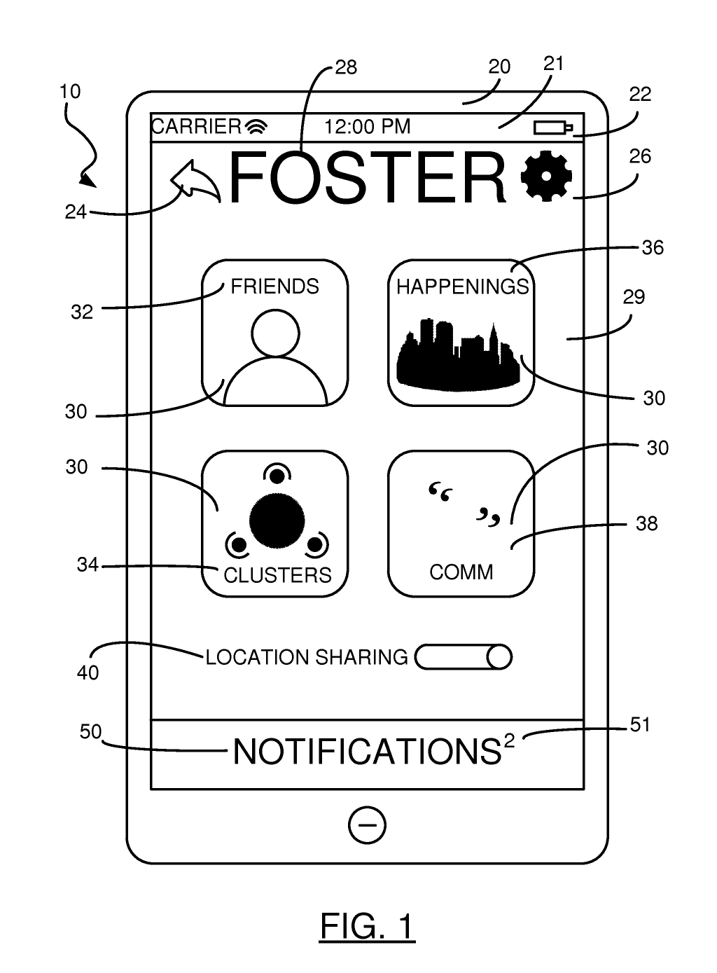

Referring now to FIG. 1, the system 10, which may also be referred to as an app, will now be discussed generally. Skilled artisans will appreciate that the term “app” is an abbreviated form of the term, “application,” which is a program or system operable using an electronic or computerized device 20. Various embodiments and examples of the system will be described herein as being operated on a mobile device and operating system. For example, mobile devices running Google Android, Apple iOS, Windows Phone OS, or other mobile phone devices and operating system may allow a registered member or user of the system to view his/her social network within the system, contact and communicate with friends, have personal interactions, search, and participate in nearby events that may be organized under the happenings panel.

As shown in FIG. 1, the system may present a user with an interface 21. In the interest of clarity, the home page 29 is shown on the interface 21. The home page may include buttons 30 that provide access to various panels, such as a friends panel, happenings panel, clusters panel, and communication panel. More specifically, a friends button 32 may provide access to the friends panel. Similarly, a cluster button 34 may provide access to the cluster panel. Likewise, a happenings button 36 and communications button 38 may provide access to a happenings panel and communications panel, respectively.

To activate the buttons 30, a user may engage the area on a screen where the button is located. The screen may be a touch screen and may register the contact or proximity of a detectable object, such as a user's finger or stylus, to determine that the button 30 has been engaged. The screen may be a capacitive touch screen, as will be appreciated by skilled artisans without limitation. However, additional embodiments including a resistive touch screen, a screen without touch sensitivity, or other display will be apparent to skilled artisans after having this benefit of this disclosure. Similarly, one or more physical button may be included in the computerized device 20, which may be used to engage one or more of the before mentioned buttons.

Skilled artisans will appreciate additional panels that may be included with the system after having the benefit of this disclosure. The friends panel may provide screens through which a user can search and add users as friends. The users may also access member and friend locations. Friends, users, and other members may be organized lists. The user may also create and view events and deals by engaging the happenings panel. Additionally, users may create or join clusters and communicate with people who may or may not be associated as a friend. Users may also communicate with one another via chat and message board features. These panels will be discussed in greater detail below.

The home page may include an information bar 22, which may display status and activity information such as a connected wireless carrier, battery level, and other information. The home page may also include a back button 24, which may be included in substantially all screens to return to a previously viewed screen. The back button 24 may also be used to sign-out a user, when engaged from the home page 29. A confirmation may be provided to verify the user intent to sign-out of the system. Additionally, a configuration button 26 may provide access to a utility to configure user and/or system settings, which will be discussed in greater detail throughout this disclosure. A label 28 may be included to indicate the name of the present application or system. The label 28, “FOSTER,” has been provided for illustration purposes.

A location button 40 may be included to enable and disable location sharing within the application. Skilled artisans will appreciate that disabling location sharing may include disabling the location module, location detection device of the computerized system, denying the uploading of location based information using the system, or using another technique to prohibit location-based data from being transmitted across a network to other users.

A notifications bar 50 may be included on the home page 29. A user may access the notification bar 50 to receive status and information relating to the operation of the system. The notifications bar 50 may include a notifications indicator 51 to quickly alert a user as to a quantity of notifications currently unread or pending.

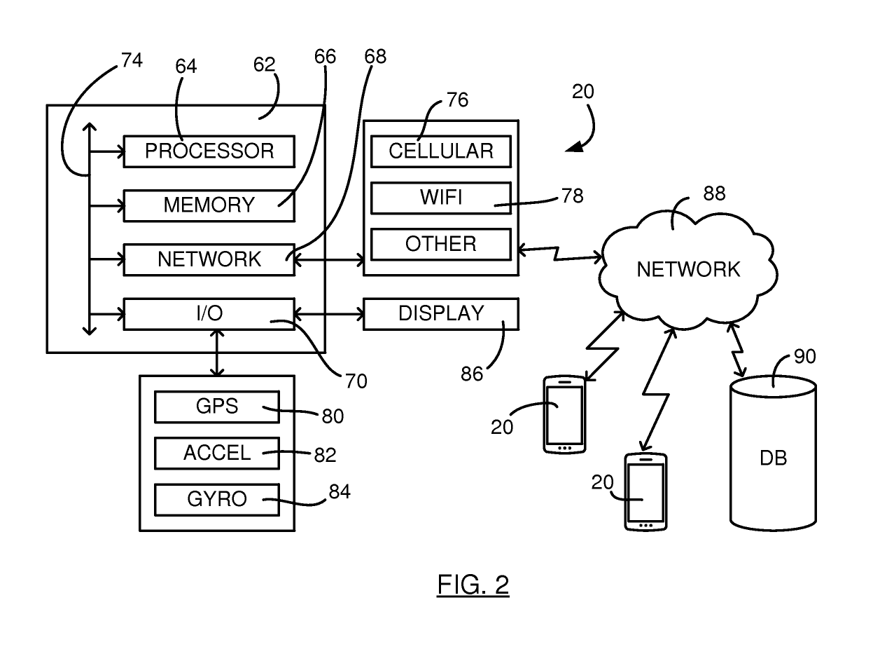

The system may be operated on a computerized device 20, which will now be discussed along with the block diagram of FIG. 2. A user may access the interface 21 using a computerized device 20. The computerized devices 20 may connect with the system 10 and other computerized devices 20 directly or over a network 88. Skilled artisans will appreciate that the embodiment illustrated by FIG. 2 has been provided in the interest of clarity, and is not intended to limit the present invention in any way. The system 10 may include, generally, a computerized device 20, a database 90, a network 88, and one or more connected device.

The computerized devices 20 will now be discussed in greater detail. The computerized device 20 may include a processor 64, memory 66, network controller 68, and input/output (I/O) controller 70. Skilled artisans will appreciate additional embodiments of a computerized device 20 that may omit one or more of the aforementioned components or include additional components without limitation. In at least one embodiment, the processor 64, memory 66, network controller 68 and I/O controller 70 may be included in a single package or controller 62, the components of which may all be connected to and communicate via a bus 74. The processor 64 may receive and analyze data. The memory 66 may store data, which may be used by the processor 64 to perform the analysis. The memory 66 may also receive data indicative of results from the analysis of data by the processor 64.

The memory 66 may include volatile memory modules, such as random access memory (RAM), or non-volatile memory modules, such as flash based memory. Skilled artisans will appreciate the memory 66 to additionally include storage devices, such as, for example, mechanical hard drives, solid state data, and removable storage devices.

The computerized device 20 may also include a network controller 68. The network controller 68 may receive data from other components of the computerized device 20 and communicate the data with other computerized devices via a network 88. More specifically, without limitation, the network controller 68 may communicate and relay information from one or more components of the computerized device 20, or other devices and/or components connected to the computerized device 20, to additional connected devices. Connected devices are intended to include databases 90, data servers, additional computerized device 20, mobile computing devices, smart phones, tablet computers, and other electronic devices that may communicate digitally with another device. In one example, the computerized device 20 may be used as a server to analyze and communicate data between connected devices.

The network controller 68 may be connected to one or more network communication radios, which may transmit data using a connected network 88. Alternatively, one or more network communication radios may be included within the controller 62, without limitation. Examples of network communication radios may include cellular 76, WiFi 78, Bluetooth, or other networks interfaces through which data may be transmitted and/or received data. The system 10 may also connect to one or more device in the network 88, such as a server or database 90, using a physical or wired connection.

The computer may also include an I/O interface 70. The I/O interface 70 may be used to transmit data between the computerized device 20 and peripheral devices. Examples of peripheral devices may include, but should not be limited to, a display 86, external storage device, human interface device, printer, sound controller, or other components that would be apparent to a person of skill in the art. Additionally, one or more of the components of the computerized device 20 may be communicatively connected to the other components via the I/O interface 70.

Receipt and transmission of data may be controlled with respect one or more particular operations of the system. For example, the system may limit data being transmitted relating to a cluster to be restricted to user within that cluster. Alternatively, the system may allow and possibly filter part of the data resulting from transmission of a user or source outside of the cluster. As another example, the system may be configured to share location based data only with one or more users within a particular list, cluster, or other grouping.

The system may include location or motion sensing components, which may be connected to the computerized devices 20, for example, via the I/O interface 70. Alternatively, the location and/or motion sensing devices may be included within the controller 62. The location sensing components may be included in a location module, which may similarly be included in or connected to a computerized device 20. As examples, the location module, which may include location and motion sensing device such as a global positioning system (GPS) 80 to detect a geographic location, accelerometer 82 to detect force or motion, and a gyroscope 84 to detect rotation. Skilled artisans will appreciate a geographic location to include the physical location of a user with respect to his or her physical surroundings.

The computerized device 20 may communicate with one or more connected devices via a network 88. The computerized device 20 may communicate over the network 88 by using its network controller 68. More specifically, the network controller 68 of the computerized device 20 may communicate with the network controllers of the connected devices. The network 88 may be, for example, the internet. However, skilled artisans will appreciate additional networks to be included within the scope of this disclosure, such as intranets, local area networks, wide area networks, peer-to-peer networks, and various other network formats. Additionally, the computerized device 20 and/or connected devices may communicate over the network 88 via a wired, wireless, or other connection, without limitation.

A database 90 may be communicatively may be connected to the computerized device 20 and/or the network 88. In one embodiment, the computerized device 20 may be directly connected to the database 90. The direct connection may be a physical connection. Alternatively, a physical connection may be simulated using a virtualized physical connection, such as one made via a virtual private network 88, without limitation. Alternatively, the database 90 may be communicatively connected to the computerized device 20 via a network 88. A communication protocol may be established by which the computerized device 20 and the database 90 may exchange data.

The system 10 may include a server, which may communicate with connected devices via the network 88. As an example, the server may interact with the connected device, such as a smartphone, using REST/XMPP web services, returning JSON objects. The server may store the recorded location data within the native device or it can be transmitted to a central location database, for example, MySQL.

The system 10 may also include an interface operable on a connected device, such as a smartphone. For example, using a connected device operating on Apple's iOS operating system, the system may include an iOS application that follows Apple's Human Interface Guidelines. These guidelines can be implemented in to the smartphone application to provide an interface that is to make its use intuitive, simple, and effective. Some of the usability features could be hinted, but not described, as the user will likely discover the features by themselves.

The system 10 may also provide maps to a user, which will be discussed in greater detail below. The system may download data for the maps over the network 88. For example, the system operating on iOS may rely on Apple's Google maps API's for retrieving mapping data alongside event creation. In several instances, custom parameters may be used for implementing the associated UI alongside the feature.

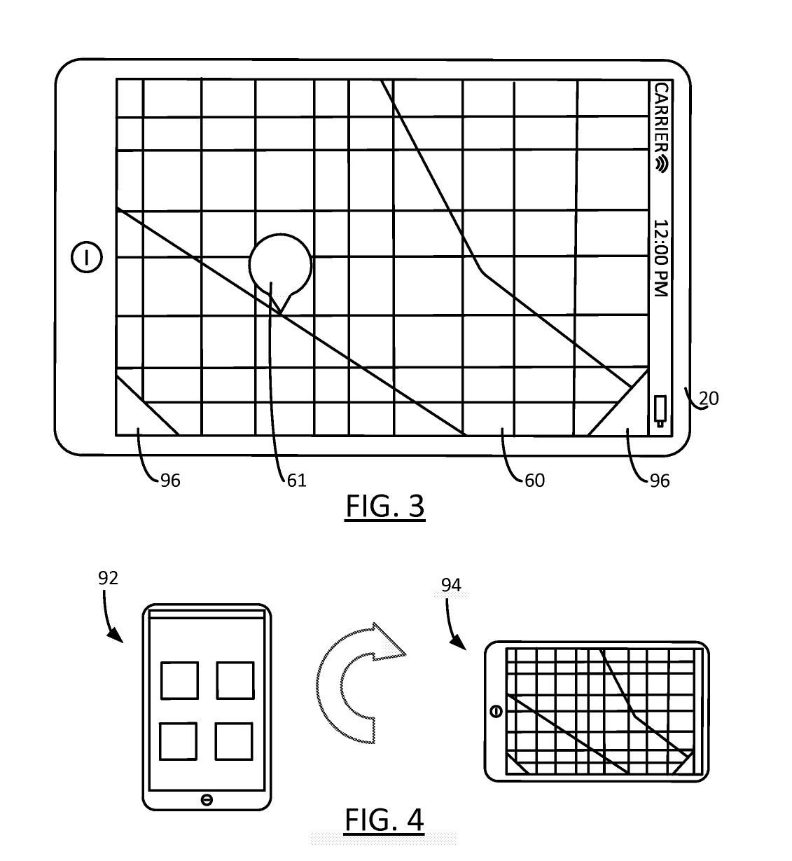

The system 10 may detect the orientation of a device. For example, the system may detect if a smartphone operating the application is oriented in the portrait or landscape manner Those of skill in the art will appreciate that a portrait orientation differs from, and is not directly related to, a photographic portrait that may be used in creating a user profile, as will be discussed in greater detail below. Portrait orientation of a display may be accomplished when the height of the screen is greater than the width of the screen. An example of portrait orientation is provided by FIG. 1. Conversely, landscape orientation of a display may be accomplished when the width of the screen is greater than the height of the screen. An example of landscape orientation is provided by FIG. 3. The map 60, which may include one or more markers 61, of FIG. 3 will be discussed in greater detail later in this disclosure.

A device may be alternated between portrait and landscape orientations by approximately rotating the device approximately 90 degrees in the clockwise or counter-clockwise direction. An example of the device being rotated from a portrait orientation 92 to a landscape orientation 94 is also illustrated in FIG. 4. The device may also be able to automatically adjust the interface displayed on the screen so that the interface is oriented on the display to correspond with a viewing angle of a user. In other words, device may detect the orientation of the display, and may present the interface to a user that is right-side-up, and not upside-down.

The contents of the interface may be controlled by manipulating the device between portrait 92 and landscape 94 orientations. For example, when oriented in the portrait position 92, the system may present the user with the home page 20, panels, or other screens. Alternatively, when oriented in the landscape position 94, the system may present the user with a map 60. The data displayed in the portrait and landscape orientations may be interrelated. For example, the map 60 of the landscape orientation 94 may include one or more markers 61 that are relevant to the information displayed in the portrait orientation 92. Panels, screens, and the map 60 will be discussed in greater detail throughout this disclosure.

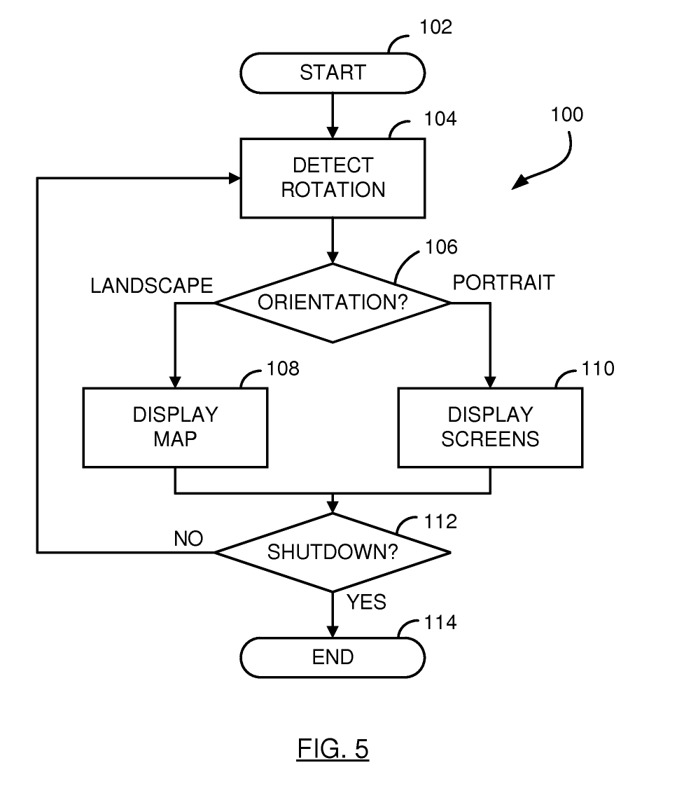

Referring now to flowchart 100 of FIG. 5, a model operation of rotation detection will now be discussed. Starting at Block 102, the system may detect whether the device has been rotated (Block 104). The rotation may be detected using the accelerometer 82, gyroscope 84, or other motion detecting component included in, or connected to, the computerized device. Alternatively, the orientation of the device may be manually indicated by a user through the interface. Upon detecting rotation, the system may determine the present orientation of the device (Block 106). If it is determined that the device is oriented in the landscape position 94 at Block 106, the interface may be switched or configured to display the map (Block 108). Conversely, if it is determined that the device is oriented in portrait position 92 at Block 106, the interface may be switched or configured to display the screens (Block 110). The screens may include the home page, screens associated with a panel, or any other display of information other than the map.

The system may then determine if a shutdown command has been received for the present operation (Block 112). If no shutdown command has been received at Block 112, the system may return to the operation of Block 104, wherein it may again detect for rotation of the device. If a shutdown command is received at Block 112, the operation may then terminate at Block 114.

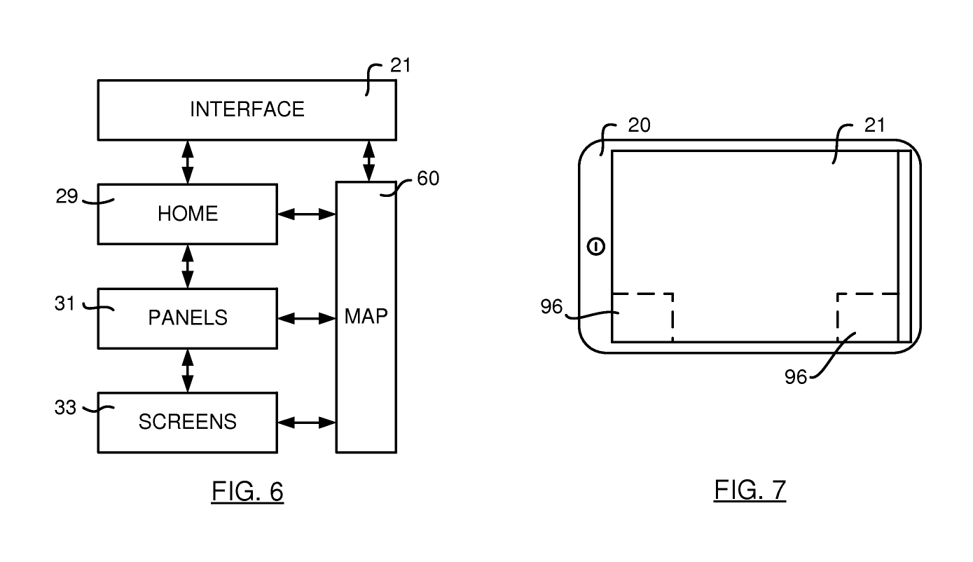

The system may be switched between displaying the map in the landscape position 94 and displaying the screens in the portrait position 92 substantially freely and fluidly. Referring now to FIG. 6, a block diagram illustrating the structure of the system, as it may be displayed by the computerized device 20, will now be discussed. The system may be accessed and manipulated by a user through an interface 21. The interface 21 may include on-screen virtual buttons and may interact with physical buttons or detection components, such as an accelerometer 92 or gyroscope 84. Using the interface 21, the user may access the home page 29 illustrated in FIG. 1. Through interaction with the interface at the home page 29, the user may access the panels 31, which include screens 33 to control the various features of the system. The system may resemble a hierarchical system, through which the screens 33 may be categorized into panels 31, the panels accessible through the home page 29.

Additionally, the map 60, which is perhaps best illustrated in FIG. 3, may be accessed from the home page 29, panels 31, and/or screens 33, and vice versa. As discussed above, along with FIGS. 4-5, the user may switch between viewing the panels/screens 31/33 and the map 60 by manipulating the device, for example, by rotation. Upon rotating the device to landscape mode 94, the system may remember a state of the interface 21 prior to switching to the map 60. Then, when the device is rotated back to portrait mode 92, the system may recall the state of the interface 21 and allow the user to continue using the system from where he or she left off before engaging the map 60.

Using a computerized device 20, the interface 21 may recognize hot corners 96, which will now be discussed along with FIGS. 3 and 7. Users may interact with the hot corner 96 by engaging the area of the interface included within a hot corner 96, or issuing a hot corner command. The user may issue commands using one or more hot corner 96 to control various aspects of the system.

In the interest of clarity, hot corners 96 will be discussed in the context of the map view 60, which is illustrated in FIG. 3. As discussed above, the map 60 may be accessed when the device is rotated to the landscape position 94. Skilled artisans will appreciate additional embodiments wherein hot corners 96 may be included in the portrait position 92.

The map view may have two hot corners 96, or virtual buttons at the bottom left and right corners, which a user can engage. Skilled artisans will appreciate additional locations at which a hot corner 96 may be defined, which may or may not be in a corner. The hot corner 96 in the bottom left corner may include a magnifying glass icon. This hot corner 96 may initiate a search function for the map 60. For example, a user can search for friends and clusters on the map, or whatever the user has filtered. The hot corner 96 in the bottom right corner may include an eye icon. This hot corner 96 virtual button may initiate a filter function for the map 60. A user can filter by friends and clusters as well as specifying map 60 filter options in terms of zoom range and map type.

The hot corners 96 may also expand from the bottom left or right corner to the top left or right corner, filling the screen. The full screen display can be minimized, for example, by clicking an arrow icon at the top left or right corner of the screen. This system of filtering and searching advantageously maximizes screen real estate on the map 60. Skilled artisans will appreciate additional locations and functions of hot corners 96, which are intended to be included within the scope of this disclosure.

A user may interact with the system to gather information relating to a locality and communicate with friends. Illustrative operations will be provided below to clearly demonstrate such interactions. However, those of skill in the art will appreciate alterations to the steps described below that would produce substantially the same results. These additional embodiments are intended to be included within the scope of the present invention.

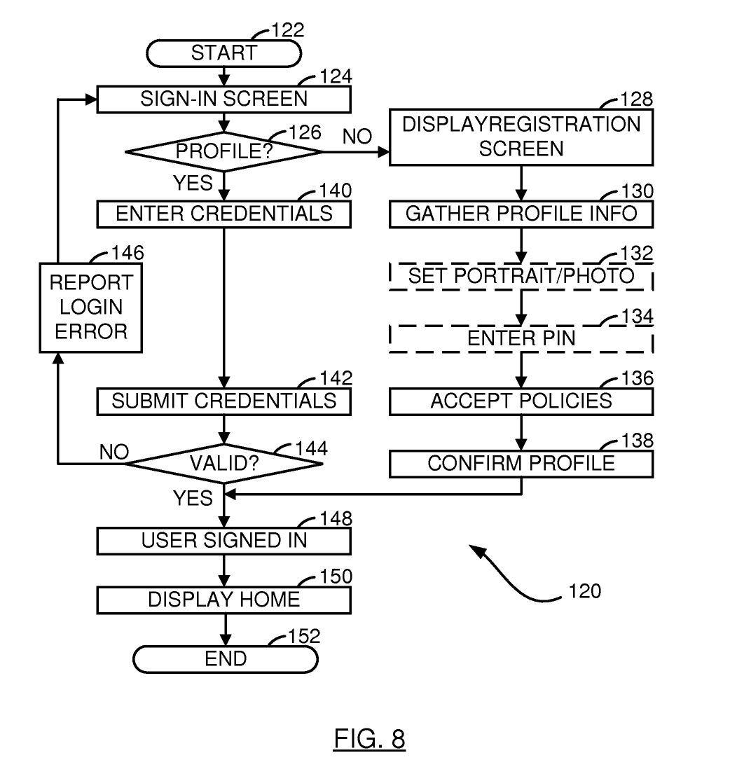

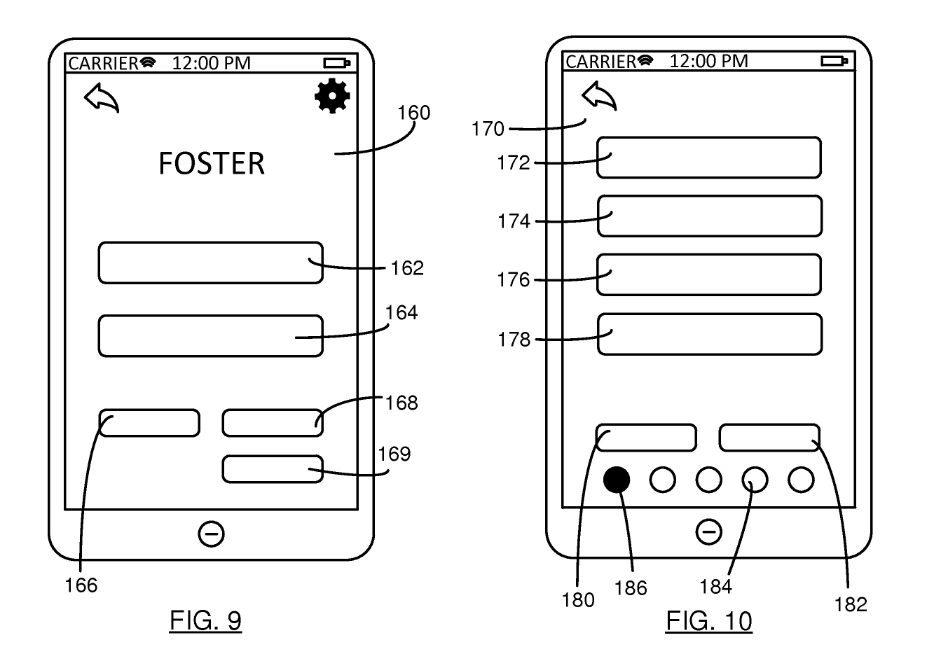

A user may be required to log into the system to gain access to the interface. An illustrative operation of logging into the system will now be discussed along with flowchart 120 of FIG. 8. Starting at Block 122, the system may display a sign-in screen to the user (Block 124). An example of the sign-screen 160 is illustrated in FIG. 9. The sign-in screen may include, for example, a field for an email address 162, password field 164, “Forgot password?” button 166, “Sign In” button 168 and a “New to Foster?” text string accompanied by a registration button 169. Engaging one or more of the fields may call a pop-up menu or onscreen keyboard, which may be used to enter information into the field.

Once the user enters his or her credentials, the system may determine whether the user attempting to access the system presently has a profile (Block 126). For example, the user may engage the registration button 169 to initiate the registration process. If the user does not have a profile, the system may direct the user to a registration screen to create a profile (Block 128). In this example, the registration process is divided into five screens. However, skilled artisans will appreciate additional embodiments to accomplish a registration that include more or less steps consistent with the scope and spirit of the present invention.

The current step of user registration may be indicated by “slider dots” 184, or dots oriented on the screen to indicate which step of a total number of steps the user is presently completing. An example of slider dots is illustrated in FIG. 10, which shows the interface at an initial step of registering a profile 170, as described along with Block 128 of FIG. 8. As shown in FIG. 10, the current page dot 186 may be indicated with a darkened color, and the rest of the dots 184 may be greyed out or otherwise distinguished from the current page.

At the initial screen of the registration process 170, the user may be prompted to enter his or her full name in a first field 172, which may be a text only field. If the user enters any numeric or special characters and hits the proceed button 182, the app may show a pop-up error message. Also, the user enters more than one space between the first and last name, the app may truncate the space to just one. The user may also be prompted to provide an email address in a second field 174. The email address provided by the user may be the email address as registered by the system unless an invitation with a code. An invitation code, if required, may be received by a user from an existing member of the system.

A password may be provided in a third field 176. The format of the password may be restricted, for example, by requiring a minimum length of 6 and maximum of 25 characters. The user may also be prompted to confirm the password at a next field 178. The data in field 178 should match the data entered in field 176. If the user engages the proceed button 182 and match of fields 176 and 178 is unsuccessful, the app may show a pop-up error message.

The data gathering screen 170 may include a back button 180 to take the user to the home page and a proceed button 182 to take the user to the next screen of the registration process. Progression to the next screen of registration may be denied if the user has not entered valid information, as explained above, in all the fields. The back and/or proceed buttons 180, 182 may be included on additional screens throughout the registration process of Blocks 128-138. Gathering of the data to create a profile is represented as Block 130 of FIG. 8.

Referring back to flowchart 120 of FIG. 8, the operation may then proceed to set a portrait for the user (Block 132). The interface screen of the registration process may present a number of options by which the user can supply a portrait to the system. Skilled artisans will appreciate that the term “portrait” is being used in this context to describe a photograph, avatar, or other visual depiction of a user, and not an orientation. The portrait may be the user profile picture and is an optional field. The system may have a stock photo if the user chooses not to upload a portrait. During the registration process, the system may not have any photo for the user in the database, and may offer options for the user to upload a picture.

A first option may allow the user to “Take a Picture Now.” Selecting this option may open up the native camera functionality. The native camera functionality may use additional applications or hardware components of the computerized device 20, for example, a camera and associated software included in a smartphone.

The user may also choose a portrait from local storage on the computerized device 20. Selecting this option may access the native media storage for the user to select a picture from. With this portrait, since the pictures will need to be square, a user may be prompted to crop the portrait with a square selector so that the image is not warped. A “Crop” button may be provided to the user with a cropping page, which may have a “Cancel” button at the top that can return the user to the previous screen or registration page. Cropping pictures may be set as a mandatory requirement. The system may have a confirmation modal window for the user to choose from “Yes” and “No” buttons to finalize the cropping of the photograph. In one embodiment, the system may have a crop box that the user can drag over the picture and click on “Done” button to save the cropped picture as the profile picture for the user.

The user may also elect to download or link to a photograph existing over a network 88. For example, a user may select to link the profile portrait to a profile picture being used by the user on another social network. Once the user has selected a portrait, the user may engage a “Back” button 180 or “Proceed” button 182 to navigate through the registration process.

The user may then be requested to enter a security code, such as a PIN number (Block 134). The PIN number may be used to protect the privacy of the user. The system may automatically lock after a period of inactivity. The PIN may allow the user to unlock and resume use of the system. Entry of a PIN code may be optional. Once the user has optionally selected a PIN, the user may engage a “Back” button 180 or “Proceed” button 182 to navigate through the registration process.

The user may then be prompted to review and accept policies (Block 136). Policies may include a privacy policy, terms and conditions, or other policies to which a user must agree. The policies may be by the system or accessed via the network 88. A checkbox or other interactive element may be provided for the user to activate, indicating that the user agrees with the policies. Once the user has selected a portrait, the user may engage a “Back” button 180 or “Proceed” button 182 to navigate through the registration process.

The user may then be directed to confirm registration of the profile (Block 138). Confirmation of the profile may include instruction for the user to check his/her email inbox and provide a confirmation code. Buttons may be provided to the user offering shortcuts to anticipated operations. For example, a button may be provided to the user with a shortcut to the email client of the computerized device 20. If the user engages this button, the system may exit and open the native primary email account configured by the user. If no email account is configured on the device, the app may take the user to the mail page where he/she may have to add an email account as per the native device rules. When the user re-enters the system or app, he/she may be directed to a registration screen by the system, wherein the user may resume the registration process.

A button may be included to allow the user to sign in. If the user engages this button, the app may open the main home page of the system, as described earlier in this disclosure. Another button may be provided to direct the user to a website. If the user engages this button, the system may exit and open the native browser with the client website. The user may also be provided to resend the confirmation email. A maximum number of confirmation emails that may be sent by the system can be defined. When the user re-enters the system, he/she may resume the current operation at the present screen.

After the user has completed the profile generation, the user may then be signed into the system (Block 148). In an alternative embodiment, a user may be directed to the sign-in screen (Block 124) or submit the profile for validation (Block 142) after completing the registration at Block 138.

Returning back to the operation of Block 126, if it is determined that the user has a presently existing profile, the user may be requested to enter his or her credentials (Block 140). An example sign-in screen is illustrated by screen 160 of FIG. 9. After entering the user name or email address and password at the appropriate fields 162, 164, the user may engage the “Sign-in” button 168, which may submit the credentials for validation (Block 142). Clicking on the “Sign in” button 168 may initiate the system to confirm the login credentials entered by the user and determine if the profile information is valid (Block 144). If the profile information does not match the system client data, after performing the operation of Block 144, an error message may pop up asking the user to verify entered details or create a new profile (Block 146). The pop up message may have an “Ok” button which when clicked on may dismiss the message and take the user back to the sign-in screen displayed at Block 124.

If the user name and password are properly authenticated at Block 144, the user may be signed into the system (Block 148). After the user is signed into the system, he or she may then be directed to the home page (Block 150). The sign-in and registration operation may then terminate at Block 152. Additionally, referring back to the sign-in screen 160 of FIG. 9, a “Forgot Password” button 166 may be included on the interface. Clicking on the “Forgot Password” button may send an email to the address as saved by the user.

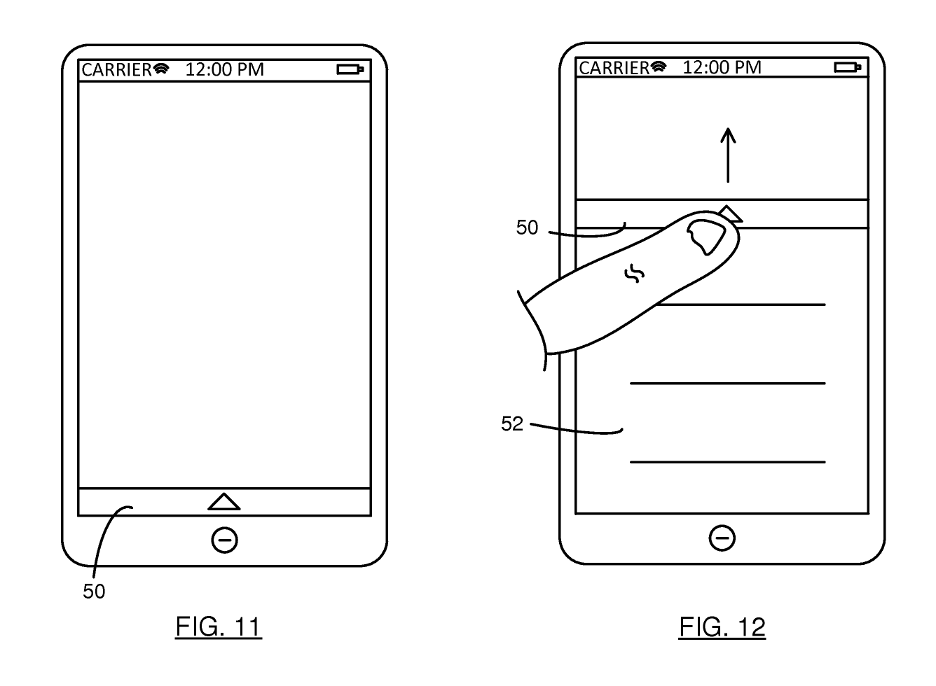

Referring now additionally to FIGS. 11-12, the notifications bar 50 will now be discussed. The system may include a notifications bar 50 at the bottom of the screen with a notifications indicator 51 (shown in FIG. 1) which may be a numeric value of the number of notifications unread by the user. The user may tap on the notifications bar 50 to open the list of notifications 52. Alternatively, the user may drag the notifications bar upward, exposing the list of notifications 52, as illustrated in FIG. 12. Once the notifications list 52 is open, the text notifications of the notifications bar 50 may be changed to an arrow. The user may tap on the arrow to close the notifications list 52. Alternatively, the user may slide the notifications bar 50 toward the bottom of the display to close the notifications list 52.

Notifications may include information about the system. For example, the notifications may include happenings notifications, such as an invitation to an event. In an embodiment, the notification may purely be a notification, without an option to accept or decline invitation in the notifications list 52. The user however, may be able to open the happening panel and bookmark the event.

Notifications may also include notifications relating to the friends panel, which may indicate a friend request has been received and/or accepted. Cluster notifications may also be provided, for example, indicating that a new member has joined a cluster. Clusters will be described in greater detail below. Furthermore, communications notifications may be received indicating, for example, a message sent directly to the user or posted in lists or cluster chats. General notifications may also be received, for example, changes to a policy, update to the system, or other news.

User users may be able to address some notifications directly from the notifications bar or list 50, 52. Addressable notifications may include accepting or denying a friend request by pressing an “Accept” or “Deny” button beside the notification, joining a cluster the user was invited to by pressing a “Join” or “Ignore” button next to the notification, or other similar interactions. The user may be able to click on the notification for a new message posted on a cluster or list chat or directly to him/her and the system may open that message. The system may also have an “x” icon for such notifications for the user to remove them from the notifications tab without being taken to the message. The system may utilize a native OS “pull-to-refresh” functionality to receive new notifications, if any. Notifications may have an associated action.

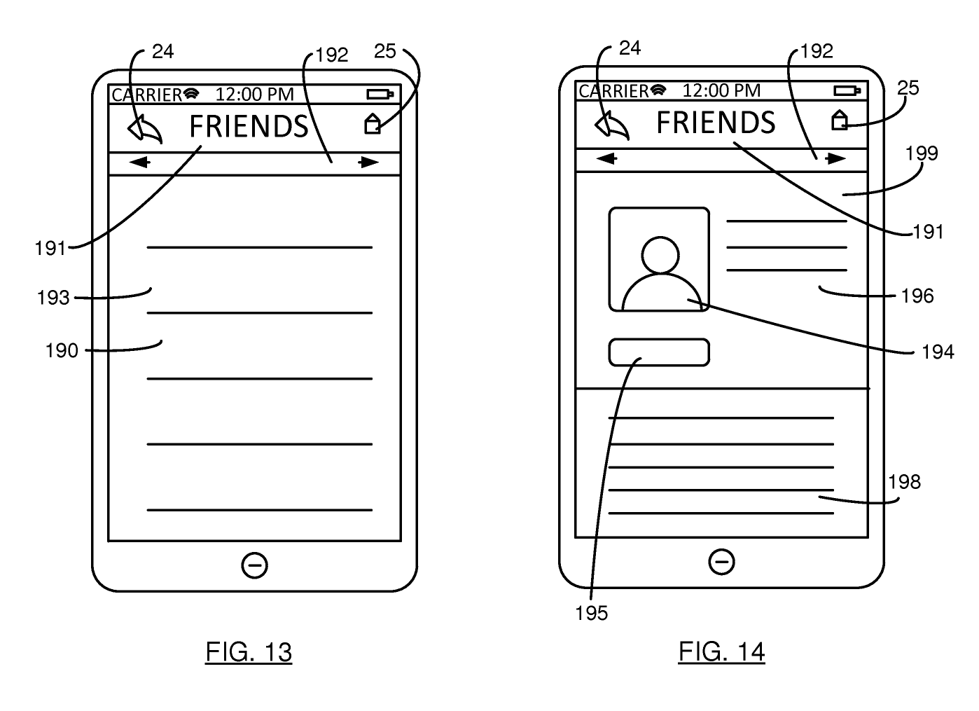

The friends panel, and screens included in the friends panel, will now be discussed along with FIG. 13. The friends panel may be accessed from the home page 29, as illustrated in FIG. 1. For example, the user may tap on the friends button 32 on the home page 29, which will provide access to the screens included in the friends panel. The friends panel may include multiple screens, each of which will be discussed below in greater detail.

The screens of the friends panel may include the text “Friends” 191 at the top center, a back arrow button on the top left 24 and a home icon 25 link on the top right to take the user to the system home page. The friends panel may include screens such as, “Me”, “All,” “Search” and “Lists.” The screens may be accessed with slider functionality 192 to navigate between the categories as well as “<” and “>” buttons. The user may swipe or slide the screen, or engage the “<” or “>” buttons, to change the views between screens of the panel. The “<” and “>” arrows may be static and indicate the current selection by swiping in the designated direction.

A default screen for the friends panel may be set. For example, the default screen for the friends screen may be the “All” screen, which is illustrated by screen 190 of FIG. 13. The “All” screen may include a list of users 193, along with some additional information. For example, the “All” screen may include a list of friends in closest proximity along with their distance from the user. The user may be able to use native OS pull down to refresh functionality to update friend's locations for distance. The user may also tap on the back arrow button to go to the previous screen.

The friends panel may also include a “Me” screen, which is illustrated in screen 199 of FIG. 14. Some of the elements from the “All” screen illustrated in screen 190 may also be present in the “Me” screen of illustrative screen 199. The “Me” screen may include the portrait 194 of the user, which would have been set during registration. If no portrait was chosen during registration, or if the user wants to change the portrait 194, the user may tap on the image and the system may show a modal window with options, such as uploading or taking a picture, as explained earlier during the registration process. If no portrait is selected, a default image may be an empty face picture may be used.

Next to the picture, the “Me” screen may include a “Status” field 196. Tapping on the “Status” field may open the native keyboard for the user to enter text. A maximum character length may be established, for example, 140 characters. The “Status” field may include a white background and rounded edges, and may have a placeholder text if the user does not enter a personal status or deletes his/her status. The “Me” screen may also have an “Account Settings” button 195, which may take the user to the account settings section.

Optionally, a “Send Invite” button may be included in one of the screens of the friends panels with a numeric value for the number of invitations left to send. The invitations may be used to advantageously build a subscriber base for the app. On clicking the send invite button, the system may open up the user contact list from the native phone book with a search bar at the top, “Cancel” button, “Undo” button and “Send Invite” button.

The system may limit the number of invites that may be sent to friends at a time. For example, if a user may only send one invite at a time, and if the user tries to select more than one friend to receive an invite, the system may display an error pop-up with message “You can only send one invitation at a time” with an “OK” button to dismiss. The system may also log the number of invites sent. If a user runs out of the allotted invites and taps on the Send Invite button, the “Send Invite” button changes to “Request More Invites”. Clicking on that button may generate more invites which may be used as explained earlier.

After selecting the contact, the user may tap on the “Send Invite” button and the system may open native messaging (text, SMS, email, etc.) feature with a message or content and a system generated code. If the user engages the “Cancel” button, the system may take the user back to a screen to select contacts. After the message is sent, the system may also take the user back to a screen to select contacts. Generated code, which may be associated with the invite, may be saved in a client database. The user may then return to the main “Me” screen 199 of FIG. 14.

The “Me” screen may have a list view of the recent user interactions 198. A maximum number of interactions may be set to display, for example, five. The user may be able to click on an item in the list to be directed to the corresponding screen/section. For example, for accepting a new friend request, tapping on that item may open the friend's profile. As another example, for the last message sent, tapping on that item may open the communications screen. Skilled artisans will appreciate additional operation consistent with the scope and spirit of the present invention, without limitation.

The system may have a “More” button at the bottom of the screen, which when clicked may display more interactions. This list may be populated from, for example, clusters that the user created or was added to, friend requests accepted by the user, friends who accepted user friend request, bookmarked happenings, and other events or actions from within the system.

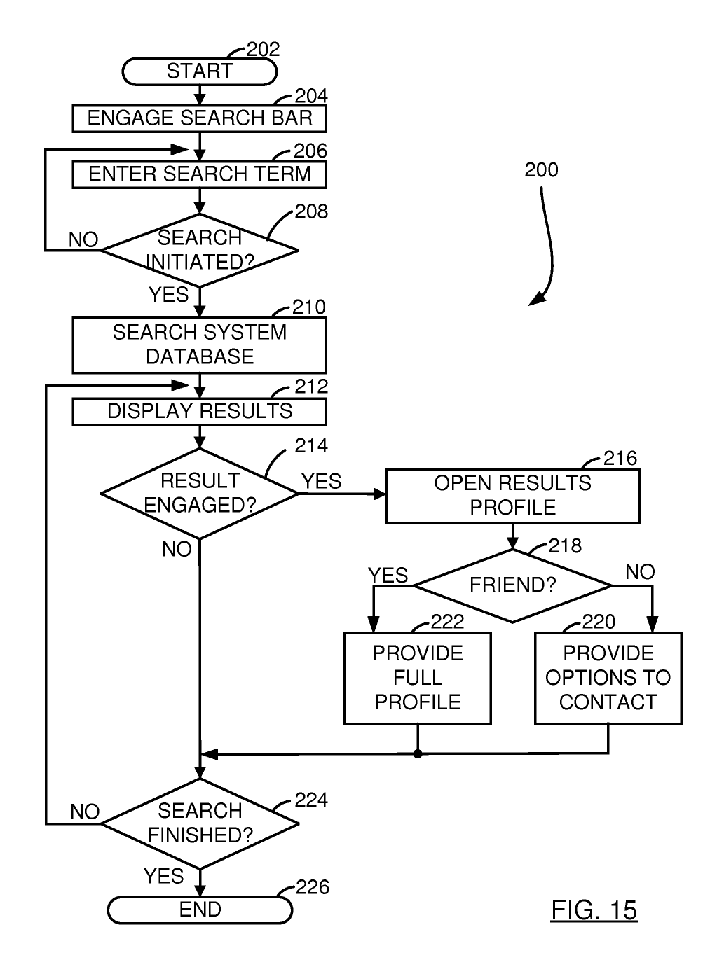

The “Search” screens will now be discussed in greater detail, along with flowchart 200 of FIG. 15. The “Search” screens may be accessed via the “All” screen or other screens. More specifically, in an embodiment wherein the “Search” screens are accessible via the “All” Screen, the “All” screen may have a search bar at the top of the screen with text “Search your friends or find new ones.” A search may be performed for users who are in the system database, or are registered users of the system.

Starting at Block 202, the user may engage the search bar (Block 204). Engaging the search bar may open up the native keyboard. The user may enter a search term, for example, a name a friend (Block 206). After the search terms have been entered, the system may determine whether the search has been initiated by the user, for example, by engaging a “Search” button (Block 208). If the search has not been initiated by the user at Block 208, the system may return to the operation of Block 206, where it may receive the search term. Conversely, if the search was initiated at Block 208, the system may then search the system database (Block 210). The system may display all the matched results on a “Search” screen in a list view (Block 212). The results may be sorted, for example, with closest distance first.

The system may detect if the user engages a search result, such as by tapping on a search result name (Block 214). If a search result has been engaged at Block 214, the system may open the profile of the result (Block 216). The system may then determine whether the result is a friend of the user performing the search (Block 218). If it is determined at Block 218 that the result is not a friend of the user, the system may provide the user with options to contact or add the search result to the user's network (Block 220). Alternatively, if the system determines at Block 218 that the result is a friend, the system may allow the user to access the search result's full profile (Block 222).

After it is determined that no result has been engaged at Block 214, or after the operations of Blocks 220 or 222, the system may determine whether the search operation has been completed (Block 224). If it is determined at Block 224 that the search operation has not been completed, the system may return to the operation of Block 212, wherein it may continue to display the search results. Conversely, if it is determined at Block 224 that the search operation has been completed, the operation may terminate at Block 226.

Now referring to screen 230 of FIG. 16, the “Friend” Screen will now be discussed in greater detail. The “Friend” screen may include a back button 24 and home icon 25, which have previously been discussed above. The friend screen may include options to view information about the friend and/or interact with the friend. The user may be able to view the profile, full name and status of the friend through the “Friend” screen. If the target profile is not yet a friend with the user, options may be provided may be provided to “Block”, “Message” and “Add as Friend.” If the user engages the “Add as Friend” button, the system may show a confirmation modal window. If the user confirms the request for friendship, the system may send an invite to the friend to approve.

In the interest of clarity, the following example of a “Friend” screen will be described in the context of a friend of the user. The “Friend” screen may include a portrait of the friend 234, which may be a picture, avatar, empty figure, or other visual representation of the friend. The information relating to the friend profile 236 may include details about the friends, for example, a name, present status, and distance of the friend from the user.

An “Edit” button 238 may be located on the “Friend” screen. Engaging the “Edit” button 238 may open up a modal window with options for “Acquaintances”, “Close Friends”, “Unsorted” and any user defined list for the user to choose from along with a “Cancel” and “Ok” button. Through the “Edit” button 238, the user may include the friend in one or more lists and/or modify information or notes about the friend.

A “Message” button 240 may be located on the “Friend” screen. The user may engage the “Message” button 240 and the system may open the messaging screen under communication panel, which will be discussed in greater detail below. The messaging capability may follow native messaging layout. Similarly, a “Call” button 242 may be located on the “Friend” screen. The user may engage the “Call” button 242 and the system may open the native Phone functionality for the user to call the friend if he/she has a phone number listed and saved.

An “Invite to Cluster” button 244 may be located on the “Friend” screen. The user may engage on this button and the system may open the clusters panel. The clusters panel will be discussed in greater detail below. Generally, the “Invite to Cluster” button 244 may open a list of current clusters the user is in, and the option to invite the friend to any of the current clusters the user is in.

A “Block” button 246 may be located on the “Friend” screen. The user may engage the “Block” button 246 to block the friend from communication with the user or to see user location. The system may show a confirmation pop-up with text (to be decided by the client) with “Yes” and “Cancel” buttons. Clicking on “Yes” may block the user and the system may show a confirmation modal and direct the user back to the friend′ page. Clicking on “Cancel” may just direct the user back to the friend page.

After a friend has been blocked, the “Block” button 246 may change to “Unblock.” By tapping the “Unblock” button, the system may unblock the friend and return the settings to default and display a confirmation modal. A blocked friend may not be able to see the user location and status or send messages via the communications panel. A blocked friend may also have limited profile visibility of the user. The blocked friend may only be able to see the user picture, name, “Edit” option, “Message” option, “Block” option and “Invite to Cluster” option. Even if a blocked friend tries to send a message to the user, it may not be sent.

If the user taps on the “Block” button, the searched contact may not be able to message or add the user. The blocked contact may be able to view user's profile but would not have buttons for “Message” and “Add as Friend.” The user however may still be able to search for a blocked friend through the search functionality

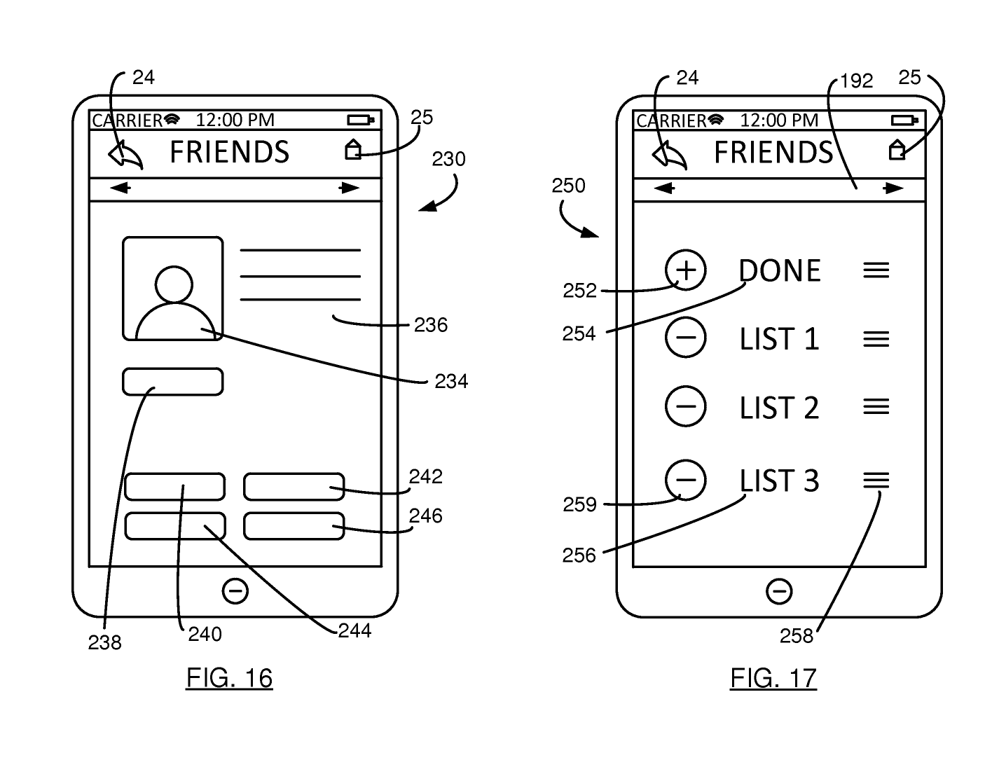

Referring now to screen 250 of FIG. 17, the “Lists” screen of the friends panel will now be discussed in greater detail. The “Lists” screen may display a number of customizable lists, into which friends may be sorted. The “Lists” screen may include default lists, for example, Acquaintances, Close Friends and Unsorted. Skilled artisans will appreciate that additional lists may be added or removed. The “Lists” screen may include a back button 24 and home icon 25, along with slider functionality 192, which have previously been discussed above.

The top cell of the page may be “Add List” button. When tapped, the “Add List” button may show a pop-up with “Add List” text and a space to enter the name for a new list. A maximum length may be set. The system may have two buttons in the pop-up, including a “Dismiss” button which may cancel all operations and take the user back to the lists page and an “Ok” button which may save the name entered by the user for the list and create the list. If the user does not enter a name for the list and taps on “Ok,” the system may show an error pop-up. Dismissing the pop-up may take the user back to the “Add List” modal window. Tapping on “Cancel” may close the modal and take the user back to the “Lists” screen.

Once created, the system may direct the user to the new list page with a “Back” button 24 at the top, and an “Edit”/“Delete” button 254. The text of the “Edit”/“Delete” button may change respective to whether the “List” screen is in edit mode. For example, upon clicking on the “Edit” button 254, the “Lists” screen may enter edit mode and change the text of the button 254 to “Done.”

FIG. 17 illustrates the list screen while in edit mode, which may show a “+” button 252 on the top left. When the “+” button 252 is engaged, the system may open a new page with the list of friends for the user with “+” against each name. Tapping on the “+” button 252 next to the friend may add that friend to the list being created. If a friend already exists in that list, the system may display a “−” button 259 for the user to delete the friend from the list. When editing of the lists has been completed, the user may engage the “Done” button 254 to finalize the created lists.

The “−” button 259 may also be used to remove a list from the “Lists” screen. The title of each list 256 may be included adjacent to the a “−” button 259 and a move button 258. The move button 258 may be provided for each list, such that the display of the lists may be reordered. A user may interact with the move button 258 by using a click and drag operation to move the list to a new position on the table, which will be understood by those of skill in the art.

Attempting to delete a list may show a confirmation pop-up. If the user selects a “Yes” option, the system may delete the list and remove the friends from that list. If the friend is in another list, the friend may remain in that list. Conversely, if the friend is not in another list, the friend may be moved to an “Unsorted” list. Friends of a user can be in multiple lists at the same time. If location sharing settings for the two lists is different, the system may make “On” as the default setting for that friend. Skilled artisans appreciate that the user can define or delete virtually any list, and that the lists named in the examples of this disclosure are not intended to be limiting in any way.

As an example, friends included in an “Acquaintances” list may not be able to see the location of the user. The user may change these settings, using the location sharing preferences for the settings of the list. Alternatively, for example, friends may be included in a “Close Friends” may by default be able to see user location. The user may be able to change these settings, under the location sharing area of the list. Any friends that are not in “Acquaintances” or “Close Friends” may automatically be added to an “Unsorted” list. Once added to a list, they may be removed from the “Unsorted” list. New friends may be first added to an “Unsorted” list. “Acquaintances” and “Close Friends” lists, if included, may initially be empty.

The happenings panel will now be discussed in greater detail. The happenings panel may include a number of screens, which may include a screen for “Events,” “Deals,” “Create,” and “Search.” The “Events” screen may include information relating to gatherings, street fairs, concerts, sporting events, and other activities in which people may gather. Skilled artisans will appreciate similarities in the interfaces between the buttons, displays, and layouts of the happenings panel and friends panel, while still respecting the differences between the panels.

The “Deals” screen may include information relating to commercial transactions, which can involve a business. To obtain or use a deal, a user may be required first meet a minimum cluster size (if applicable). Then the user may then shows a verification image to a cashier, manager, waiter, salesman, or other person at the business at which the deal may be redeemed. The verification image may be selected by the business at the time of deal creation and is meant to be unique, easily identifiable, and somewhat hard to duplicate, however there are no limitations on what the verification image can be and the business can choose whatever they want. If a deal has a minimum cluster size, then all people in that cluster may be required to show the verification image at once in order to use the deal.

The “Create” screen of the happenings panel may allow a user to create a happening, such as an event or deal. The “Search” screen may allow the user to search happenings, which may operate similarly to the search operation discussed along with FIG. 15.

The user may engage the screens of the happenings panel by engaging the happenings icon 36 on the home page 29, illustrated in FIG. 1. The system may open the happenings panel, which may have text “Happenings” at the top. Similar to the other panels in the interface, the happenings panel may include a back arrow button on the top left and a home icon link on the top right to take the user to the home page. Some bookmarked. The user may navigate through the screens of the happenings panel with slider functionality to navigate between the categories as well as “<” and “>” buttons, similar to the navigation of the friends panel. The user may use the native swipe slide functionality to change the views between categories. The arrow may be static and indicates the current screen selection.

The “All” screen of the happenings panel will now be discussed. The default view for the happenings panel may be the “All” screen. The user may engage the back arrow button to go back to the home page or the Home icon to go to the home page.

The “All” screen may display all the happenings that are in the system database. The happenings may be sorted by a number of filters, for example, categories and time. If filtering the happenings by category, for example, the system may display the following mentioned categories with icons as a vertical list with scroll functionality. The sortable categories may include, but should not be limited to, “Friends,” “Food,” “Coffee,” “Nightlife,” “Shopping,” “Arts & Entertainment,” “Outdoors,” “College” or other categories.

The user may select a category and the system may open a new page with text “Category: xyz” at the top with a Search bar. Search may be performed for happenings that are in the system database for the selected category only. Alternatively, happenings may be searched generally. Skilled artisans will appreciate the search operation may resemble a search performed from the friends panel, as discussed above along with FIG. 15. Tapping on the search bar may open up the native keyboard. The user may have to enter a name to search for a happening and tap on a button to begin the search. The system may display all the matched results in a list view. The results may be sorted, for example, being displayed as per the closest distance first.

The user may tap on a search result name for more information about the result. If the search result is already in the user event list, the system may open the event page with all features as explained in this document. If the search result is not in the user event list, the user may be able to tap on the happening and bookmark it for future reference.

The system may display the results in a vertical list format. The system may, for example, display ten proximately closest happenings to the user. A “Load More” button may be included at the bottom of the screen, which when clicked may show ten more happenings. The user may be able to do this indefinitely till there are no more happenings to display by the system.

If there are no happenings in the system database that match the search parameters, an empty results page may be presented to the user, which may include text that says, “Create Happening.” Clicking on which may take the user to “Create” screen. The “Create” screen will be discussed in greater detail below.

If time is selected as the sorting mechanism, the system may display the sorted by, for example, “all,” “day,” “week,” or other term. The “all” filtered search results may have a “Search” bar under the above mentioned screens with text “Search nearby happenings.” Search may be performed for happenings that are in the system database, which may be created by registered users. Searching and browsing the results of time-filtered search may be performed similarly to that of a category-based search.

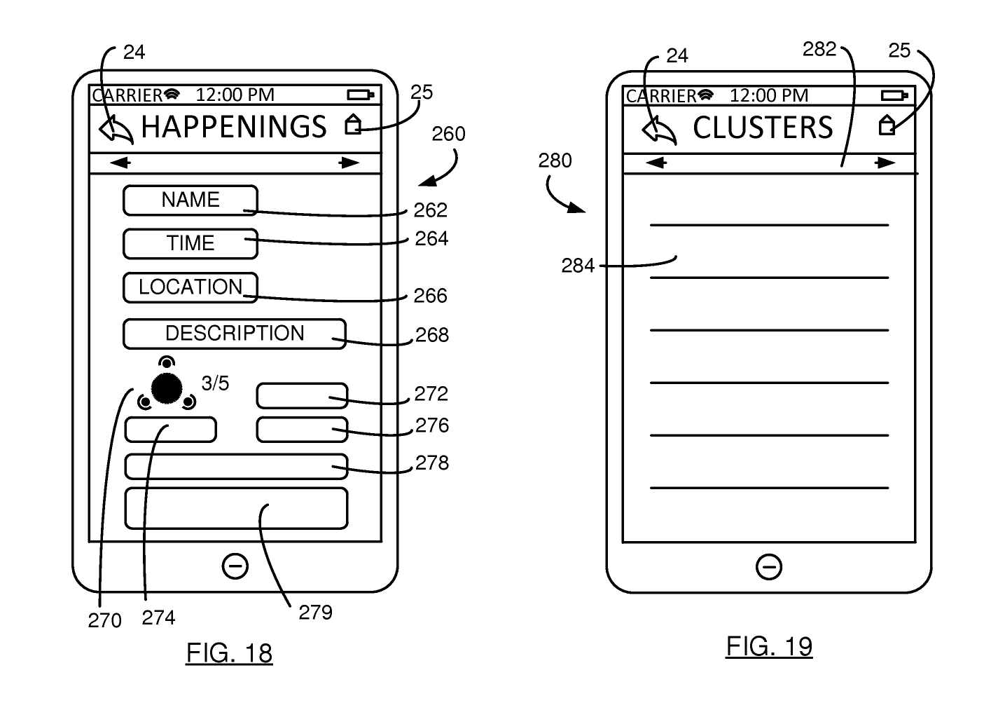

If the search result is not in the user event list, the user may be able to tap on the happening and bookmark it for future reference. The user may tap on a happening name and the system may open a new page with the happening details, which is illustrated by the “Deals” screen 260 of FIG. 18. The happenings details may include may include a name 262, date and time 264, location 266, and details 268. The “Deals” screen may also include a cluster ratio 270, “Go To Clusters” button 272, “Get Directions” button 274, “Use Deal” button 276, field to post on message board 278, and message board 279. A back button 24 and home icon 25 may also be included for navigation purposes, as discussed previously in this disclosure.

A “Build Cluster” button may optionally be included on the “Deals” screen. When the user taps on the “Build Cluster” button, the system may open the clusters panel with relevant information. Clusters will be discussed in greater detail below. The “Go” or “Get Directions” button 274 may be included on the “Deals” screen. Engaging the “Get Directions” button 274 may open the native maps application to the computerized device, for example, Google maps, with directions to the event.

The screens included in the happenings panel may include a “Bookmark” button. The “Bookmark” button may be used to add an event to a “Bookmarks” screen, which will now be discussed in greater detail. The “Bookmarks” screen may have a list of all happenings bookmarked by the user in a list view. If there are no happenings bookmarked by the user, the system may display text indicating the lack of bookmarks for the user. The user may tap on the bookmarked event and the system may open a new page with event details as explained earlier.

The system may have check box functionality for all bookmarked happenings. Tapping on one or more boxes for the event may open up a “Delete” modal window. The user may tap on the “Delete” button and the system may show a confirmation pop-up. By selecting the “Yes” option, the system may delete the event from the bookmark page. Selecting the “No” option may take the user back to the list.

The “Create” screen will now be discussed in greater detail. When the user taps on the “Create” screen, the system may show a new page with the user to enter information. The user may define a name for the event to be created by tapping on the name field to open the native keyboard. This field may have the name visible to all system users to search with. The user may also create a description of the event. The event description may be optional.

The user may classify the event into a category. The system may display a list of categories for the user to choose from, for example, with check box functionality. The user may be able to tap on and check a maximum number of categories for a happening, for example, three. If an excessive number of categories has been selected, the system may display an error pop-up saying “You can select maximum of three categories” with a “Dismiss” button if the user tries to select a fourth category. The system may save the choices for the happening to be later used for displaying in the “Categories” sort tab under “All” happenings page.

The user may then select a data and time for event. The user may also designate a location for the event. More specifically, the user may enter the address of the location. The system may have a native map application with the computerized device and/or mobile OS with satellite and/or map view displayed on the page which may locate the entered address and display in with a pin or marker 61 (FIG. 3). If the location cannot be found, the system may display an error message saying “Location cannot be found. The user may have to enter a different address.” The system may make use of a native mapping API, such as, for example, Google map APIs, for this mapping functionality. The user may optionally designate a name for the location of the event being created.

The user may also be able to invite friends to the newly created event. Clicking on a button to invite friends may open up the list of friends the user has with check box functionality. The user may check all the friends he/she wants to invite and click on “Send Invite” button at the bottom. The friends may get the event invite as a notification in their app under notifications, as displayed by the notifications bar 50.

A “Delete” button may be provided to delete the event and all related information. Tapping on the button may show a confirmation pop-up first. Happenings created by the user may automatically be bookmarked and added to the Bookmarks screen.

The cluster panel will now be discussed in greater detail, along with the screen 280 of FIG. 19. Clusters are transient groups that allow people to effectively and temporarily communicate with each other and see each other's location for the purpose of organizing an activity or finding something to do. Users in a cluster may be able to see each other's location even if they are not friends. Users can be in clusters with people who are not their friends but may be restricted as to who the user may invite, for example, only their friends. Clusters may have no administrators, and can exist long after the creator leaves them. Users can leave a cluster at any time, and the cluster still exists until there are no more members left.

The user may access the cluster panel by engaging its icon 34 on the home page 29 (FIG. 1). The system may open the clusters panel, which may have text “Clusters” at the top center, a back arrow button 24 on the top left and home icon 25 on the top right to take the user to the home page 29. A list of available clusters may be provided in the body of the screen, such as illustrated by location 284.

The system may categorize the clusters panel into screens for “All,” “My Clusters” and “Create,” with slider functionality 282 to navigate between the categories as well as “<” and “>” buttons. Skilled artisans will appreciate similarities with the organization between the slider functionality and buttons with the other panels, while respecting the differences between the clusters panel and the other panels. Users may use the native swipe slide functionality, or engage the “<” and/or “>” buttons, to change the views between screens within the clusters panel. The arrow may be static and indicates the current selection. Default view for the clusters panel may be the “All” screen, which is illustrated by FIG. 19.

A user may join a cluster either by creating a cluster or accepting the invite from an existing cluster member. Location sharing for all members in a cluster may be “On” by default. A member's global location sharing setting may take precedence over a cluster location sharing setting. For example, if a user's global location setting is “Off,” and he/she is added to a cluster where the host has a setting of “On,” the user's setting will still remain as “Off.” If there is a friend in the cluster who is blocked by the user, setting for that friend may be “Off” unless changed by the user.

The “My Clusters” screen will now be discussed in greater detail. The “My Clusters” page may include a search bar at the top of the screen with text “Search your clusters or find a new one.” Tapping on the search bar may open up the native keyboard. The user may enter a name to search for a cluster and tap initiate the search. The system may display all the matched results in a list view that is sortable, for example, alphabetically.

The user may select a search result name. If the cluster of the search result is already in the cluster list 284, the system may open an “Info” screen for the cluster. Conversely, if the search result is not in the cluster list 284, the system may show the cluster name and the number of people. The user may tap on a cluster name and the system may open that cluster on a new screen. The individual screens of the clusters panel may have tabs, or sub-screens, to provide additional information, such as, for example, info, members and chat. The tabs will be described in the same manner as screens in this disclosure.

The info tab may include the cluster name, details, and a button to invite friends. Clicking on the button to invite friends may open up the list of friends, which may be provided through the friends panel. The user may select friends from the list, for example, using check boxes. The user may check all the friends he/she wants to invite and click on “Send Invite” button at the bottom. The friends may get the cluster invite as a notification in their app under notifications with options to “Accept” or “Decline”. Clicking on “Accept” may add the friend to the cluster. Clicking on “Decline” may remove the notification and return the user to the previous screen.

The individual cluster screen may have a “Leave Cluster” button. If the user engages this button, the system may show a confirmation pop-up. Tapping on “Yes” may delete the cluster if the user was the only user. If there were other hosts, the user may just be removed from the cluster and directed back to the main clusters page.

If the user is the host of the cluster, the system may display a “Delete” button, which may delete the cluster and all related information. Tapping on the “Delete” button may show a confirmation pop-up first. If there are multiple hosts to a cluster, the delete functionality may be set to only remove the host from that cluster. In at least one embodiment, a cluster may only be completely deleted when there is only one host.

The “Members” screen of the clusters panel, for an individual cluster, will now be discussed. The “Members” screen may display all members in a cluster, along with a portrait for the member, if provided, and a “Message” button. When the “Message” button is engaged, the communications panel may be opened, which will be described in greater detail below. If the user is the host of the cluster, the system may have check box functionality against all members. Tapping on one or more boxes for the member may open up a modal window with “Kick Out” and “Make Host” buttons.

The user may select the “Kick Out” button to direct the system to remove a member from the cluster. When the “Kick Out” button is engaged, a confirmation modal window may be displayed to confirm the action. The confirmation modal may include options such as “Yes” to kick the member(s) out of the cluster and “No” to cancel the removal of a member. The member being kicked out of the cluster may optionally not get notification about him or her being kicked out of the cluster. Cancelling the kick out operation may take the user back to the list. Optionally, the system may configure such that a host may not kick out another host.

The user may assign a member as a host by engaging a “Make Host” button. Once selected, the system may show a confirmation pop-up. The confirmation modal may include options such as “Yes” to make the member a host and “No” to cancel the operation. The member being made a host may optionally not get notification about him or her change of status for the cluster. Cancelling the make host operation may take the user back to the list.

A “Chat” screen included in the clusters panel will now be discussed. The “Chat” screen may have a chat box for the user to send message(s) to other members in the cluster. The system may use the native keyboard functionality. All members in the cluster may see the messages and provide a response. Alternative, messages may be targeted to one or more members within the cluster. If the user is a host, the “Chat” screen may have a “Lock Chat” button. Locking the chat function may block the chat for all members except the hosts. The host may also be able to delete or moderate the chat messages. New chat messages may show up as a notification for the users included in the cluster.

The “Create” screen of the clusters panel will now be discussed. When a user accesses the “Create” screen, the user may enter information to create a new cluster, such as, for example name and description of the cluster to be created. The name may be visible to all users of the system and may be searchable. The description may include an event description visible to all users of the system and may also be searchable. The name and description may optionally include limits for a maximum number of characters. The description may be optional.

Once the user has defined a name and description, the cluster may be created by engaging a “Create” button. Clicking the “Create” button may create the cluster and take the user to the newly created cluster. Generally, the user that creates the cluster will be the host.

The system may have “Invite Friends” button. Similar to the operation of lists, as discussed above, creating a cluster may display a list of friends to invite to the cluster. Alternatively, if no friends are added at the creation of the cluster, a cluster may be created with no members beyond the creator. A user can invite friends to the cluster at a later time.

Clicking on an “Invite Friends” button may open up the list of friends, which may be selected, for example, using check boxes. The user may check all the friends he/she wants to invite to the cluster and click on “Send” button at the top right. Skilled artisans will appreciate alternative button labels and locations to be included within the scope and spirit of the present invention. Once the cluster invitation has been sent, the friends may get the event invite as a notification.

Users may also leave clusters to which they belong. For example, clusters panel may include a “Leave Cluster” button. If the user engages this button, the system may show a confirmation pop-up. The confirmation modal may include options such as “Yes” to leave the cluster and “No” to cancel the operation. Interface restrictions may be placed on the create cluster interface, for example, prohibiting the rotate-to-map functionality from the create cluster screen.

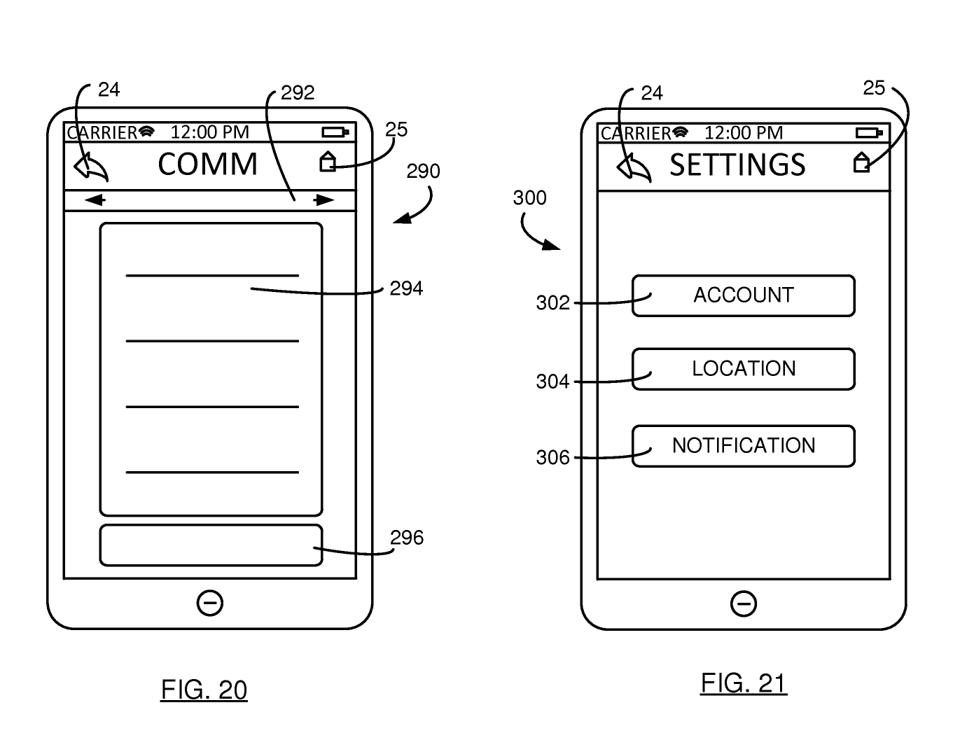

The communications panel will now be discussed in greater detail, along with screen 290 of FIG. 20. The user may access the communications panel by engaging the communications button 38 on the home page 29 (FIG. 1). In some embodiments, the communications button 38 may be abbreviated to “Comm.” Once the communications button 38 has been initiated, the system may open the communications panel. As illustrated in FIG. 20, the communications panel may have text “Communication” at the top center. A back arrow button 24 on the top left and home icon 25 to take the user to the home page 29. A number of screens may be included in the communication panel, through which the user may interact with other users.

The communication panel may be include screens for “Friends”, “List” and “Clusters,” with slider functionality 292 to navigate between the categories as well as “<” and “>” buttons. The system may have a “Compose” button 296 at the bottom of the screen, which may be included at the bottom of each screen. A user may engage the screen to initiate or continue a communication. Engaging the screen may access a collection of friends, lists, and/or clusters 294. The collection shown may depend on the screen the user is presently accessing. The friends, lists, and/or clusters may be selected, for example, using check boxes. If the user has only one variable from which to select, the system may not have check box functionality. The user may select all the friends, lists or clusters he/she wants to send a message to. The user may type a message using native keyboard functionality and click on send to transmit the message to the users.

Replies of a message, whether personally sent to a single user or generally sent to multiple users, may be alerted as a notification. Interaction with the notification by the user may navigate the user to the respective screen to view the communication.

The screens of the communication panel may include “Search” bar at the top of the screen. Users may interact with the search bar to search for and through past conversation. The search operation may be performed similarly to the search discussed above, along with FIG. 15. However, skilled artisans will appreciate that although the search for friends and communications may share, the search for each panel may be performed relative to its respective contents. For example, a user may type a name of friend, list or cluster to search to view communications associated with the search subject. The system may make use of the native keyboard to enter to the search terms.

As discussed above, the communications panel may include various screens. The user may be able to use the native swipe slide functionality to change the views between categories. The arrow may be static and indicates the current selection.

The “Friends” screen of the communications panel will now be discussed. The communications panel may include a default screen, which may be the “Friends” screen. The “Friends” screen may include a list of communications made between the user and his or her friends. The communications may be sortable, for example, alphabetically or by date. Sorting conversations by date may list conversations with the most recent activity first, with the remainder of the list descending according to time since the last activity. Sorting conversations alphabetically may sort all friend conversations in the alphabetical order of friends.

When a user starts communicating with a friend through his/her profile, as discussed above, the friend may be added to the list provided by the “Friends” screen of the communication panel.

The “List” screen of the communications panel will now be discussed. The “List” screen may display conversations engaged between the user and friends from a list. The list screen may be filtered to display only conversations for list created by the user. Messages sent using the “lists” screen may be sent to all members in that list. To communicate with a specific member of the list, the user may also use the “Friends” screen. Optionally, the user may be restricted from messaging a specific member or a friend from the “Lists” screen.

The “Clusters” screen of the communication panel will now be discussed. The “Clusters” screen included in the communication panel, and not the clusters panel, may allow the user to communicate with members of a cluster to which the user belongs. The “Clusters” screen may list the clusters the user is a part of along with the number of members in that cluster. Tapping on a cluster name may direct the user to the “Chat” screen in clusters panel. The user can tap on a cluster member who is not in the user friend list and message to the member.

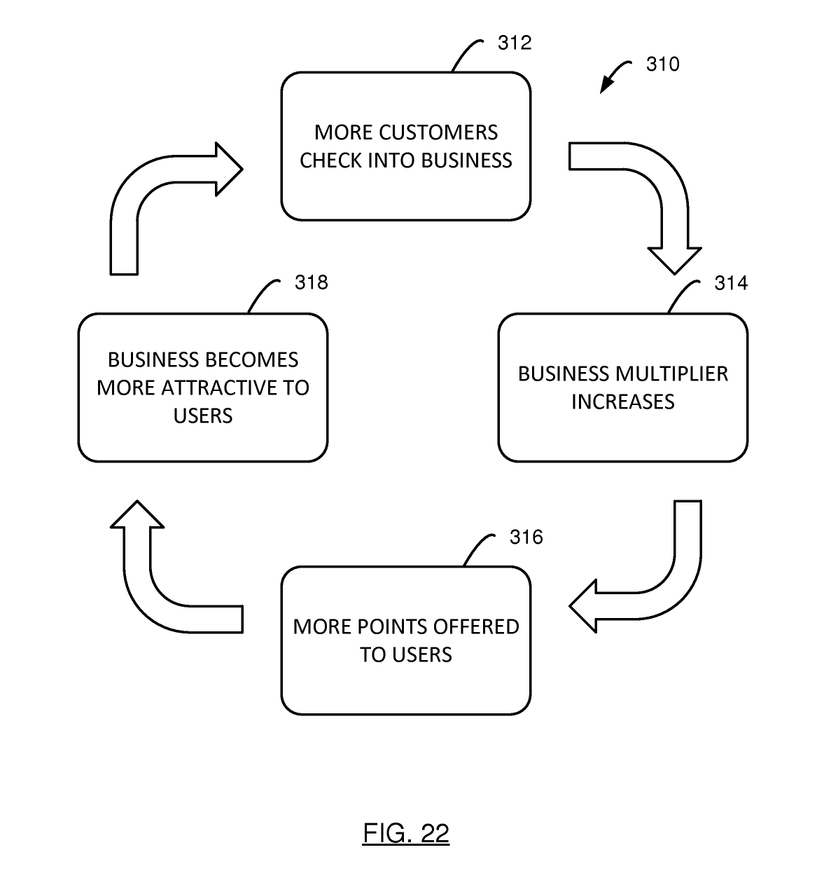

The “Settings” screen will now be discussed in greater detail, along with screen 300 of FIG. 21. Referring back additionally to FIG. 1, the interface 21, and more specifically the home page 29, may include a button 26 to access the settings screen. The settings screen may be accessible directly from the interface 21, and may not belong to any one of the panels. However, skilled artisans will appreciate that the settings icon 26 may also be displayed to the user on other screens, through which a user may access the “Settings” screen. The user may tap on the settings icon 26 on each page to be directed to the settings configuration screen, as illustrated by screen 300 of FIG. 21. The system may open the “Settings” screen, which may include “Settings” at the top center, a back arrow button 24 at the top left and/or home icon 25 to take the user to the home page 29 of the interface 21.

The “Settings” screen may allow a user to manipulate a variety of settings, such as through engaging buttons corresponding with their respective data to be configured. For examples, the “Settings” page may include buttons for account settings 302, location settings 304, and notification settings 306. Skilled artisans will appreciate additional settings that may be modified using the “Settings” screen. Optionally, users may be restricted from using the rotate-to-map from any of the Settings screens

The account settings will now be discussed in greater detail. The account settings 302 may allow a user to add, modify, or remove information relating to the account or user profile stored with the system. For example, the user may modify his or her full name, password, phone number, portrait or photograph, or other information that may relate to the user. Generally, the user may modify information consistent with the manner in which the user created a new profile, as discussed previously in this disclosure.

The system may have a “Confirm” button at the bottom of the screen, which may be used to save the user settings and direct the user to the “Settings” page. If the user attempts to confirm modification of the account settings without entering data in the above mentioned fields, the system may display an error message. The user may use the back arrow button 24 to go to the accounting settings page or “Settings” screen without changing the password and/or saving the data. The account settings may also include a “Reset” button, which, if engaged and confirmed, may reset any changes made to the account settings. The account settings may also include a “Save” button to save any changes user made, show a confirmation pop-up and direct the user to the main settings page.

The location settings will now be discussed in more detail. The user may manipulate the location settings of the “Settings” screen to define permissions for location sharing. As discussed before, location may be determined using the location module, which may include cellular radios, GPS, other triangulation methods, manual entry, or other location detecting operations. These radios may be enabled and/or disabled using the location settings. The user may select between globally enabling or disabling location sharing, defining location settings for particular lists, clusters, and other groups, or other configurations. The system may provide for a user to save his or her last known location. The location settings may include additional settings, for example, to allow the user to choose between satellite and regular map viewing in map mode. Undesired changes may be reset, and desired changes may be saved after the user is done manipulating the location settings.

The notification settings will now be discussed in greater detail. Through the notification settings of the settings screen, the user may manipulate the frequency of notifications relating to the activities of the panels. For example, a user may increase the frequency by which communication notices are received, but disable notices from a particular list of friends. Undesired changes may be reset, and desired changes may be saved after the user is done manipulating the location settings.

The map screen will now be discussed in greater detail, referring back to FIG. 3. The map screen may include proprietary mapping software, or may use a network accessed mapping system, such as Google Maps. In the interest of clarity, the following example will assume the system accesses and uses the Google Maps features of a smartphone device. The screen may integrate with Google Maps to show the user location, user's friends on the map, happenings and/or members of a cluster the user belongs via one or more marker 61. Markers relating to different information shown on the map may be distinguished from one another, for example, by color.

The markers may be interactive. For example, a user may be able to click on a marker 61 indicating a friend's location and get directions as per native maps functionality. The map may also have native pinch-to-zoom or other zooming functionality, which will be understood by skilled artisans. Tapping on the user marker 61 may display text, “You are here.” The markers 61 may be filtered to show only information from a desired panel, list, cluster, or other group.

User filter settings may be saved locally, which may allow a user to maintain search results when switching between screens provided by portrait and landscape modes. The system may have a “Focus My Location” button, which when clicked may show various options to focus the map on the user location on the map. Alternatively, this or other buttons may be provided by a hot corner 96. For example, the “Focus My Location” button may include an option for “Street” to zoom to the street level of a user's location, “City” to center the user location on the map from a zoomed out view (5 mi) and “World” which may display the map of the world with user location. The system may have a close arrow icon on the top right corner for the user to close the search view.

Markers may be collapsible for when there are a mass of people in one location. For example, if there is more than one person within a certain minimum distance, the markers for each person may collapse into a different color marker, which may visibly be slightly larger, and when clicked, will pull up markers with more names.

The markers for friends, clusters and happenings may be the colors of the logos on the app home page 29 (FIG. 1). Other coloring schemes may be used. For example, if a person in the user friend list and part of user cluster, the system may display the marker using the Friends color. Clicking on a marker may bring up the name of the friend/happening, and clicking on the text may bring the user to that particular friend/happening page.

The points system will now be discussed. The points system is an incentive system to connect users and businesses and provide both parties with a way to save money and increase influence. Users may receive points by checking into deals, and businesses have a multiplier that may be modified by registering more deals or servicing more customers/users. Users may also take advantage of deals by making a purchase funded at least in part by the points. The points may be used as a form of virtual currency, to provide a tangible reward for users of the system.

Businesses may be registered by users, which may be required to establish a business profile. A user may create a business profile through a profile creation operation similar to the user profile creation discussed above, along with FIG. 8. In various embodiments, businesses may or may not be required to create a user profile prior to creating a business profile.

Businesses may get a code, such as an alphanumeric text string, bar code, QR code, or other code when they register a deal to print out and post somewhere in their store or restaurant. Users can get points by scanning a QR code with their phone or computerized device on which the system is installed. The number of points is determined by the number of members in the user's cluster at the time the deal is accepted, multiplied by the businesses' multiplier. For example, if the user is in a cluster with 10 people, and the business that is offering the deal has a multiplier of 1.2, he/she will receive a base number of 12 points.

Thus, a user can increase the number of points he or she has by checking into more deals, checking into deals with more people, and/or checking into deals with higher business multipliers. A business can then increase their own multiplier by offering more deals, having more people check into their deals, and/or having people with large numbers of points check into their deals.

Under the deals screen, there may be a filter to organize deals by “hotness” or popularity. Hotness may be calculated by calculating a factor related to the number of people who have used the deal and the cumulative number of points of the users that checked in to the deal.

Businesses may want people to use their deals and get points because it increases the hotness of the business, makes their deal more visible within the system, and ultimately may result in more customers. Also, people will be more inclined to go to businesses with high multipliers because it means more points for the users. For that reason, businesses will be able to offer specific discounts to users with a certain number of points. For example, a user with 100 or more points can get a discount on top of a deal that they already check into.

The system provides an advantageous business model due to its circular nature, as illustrated in diagram 310 of FIG. 22. Businesses desire to attract users with a lot of points because it increases their hotness. Users desire to go to deals that are hot because a lot of people will be there and it means they'll get more points. Users will desire to be in clusters with other people who have a lot of points because it increases their multiplier. And users will desire to get points because it increases their social influence, making them wanted by both businesses and fellow users, as well as giving them additional discounts at deals. As more users realize the benefits of the points system, they will be checking into more deals, and the businesses will be offering more deals to keep up, creating a positive feedback loop of commerce.

As an example, as illustrated in diagram 310, by participating in the system and providing points to users, more customers may desire to frequent and check into a business (Block 312). As more customers check into a business, the multiplier for that business will increase (Block 314). Since the multiplier for the business has increased, more points can be offered to users from checking in to the business (Block 316). The increased amount of points offered by the business may make the business attractive to more customers (Block 318). The cycle will continue to repeat, as more customers may check into a more attractive business (returning to Block 312).

Creation of business accounts will now be discussed. Any person, such as a college student, can become a vendor for the system and help spread and advertise the businesses in their area. People desiring a business account may be given a unique vendor ID. New business account applications may be asked to type in this vendor ID of a referring business account member during the registration process. For a time period following the registration of the new business, for example, two years, the referring business account member may receive a percentage of the fee charged for deals created by the referred member. Vendors may be required to provide account information for electronic payment, for example PayPal, with vendor ID. Businesses signed up this way may have a vendor ID associated with it an electronic payment account, and may automatically receive the incentive and/or referral compensation. Vendors will be able to track their earning in real time on a web-based interface.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A networking system operable on a computerized device with a processor and memory comprising:
an interface to display information and receive data, the data being storable in a database;
panels included in the interface that are usable to access screens, the panels relating to the data accessible by the included screens;
a map to display at least part of the data with relation to a geographic location; and
a location module to determine a present geographic location, the present geographic location being usable to affect a location displayed on the map and the data provided through the panels;
wherein data is receivable and transmittable with additional computerized devices over a network using a network controller;
wherein receipt and transmission of data is conformable to occur within a cluster of users;
wherein an interaction between users is includable in the data.

2. The system of claim 1, wherein the computerized device is a mobile device with a touchscreen, the system being at least partially controllable using the touchscreen.

3. The system of claim 2, wherein the computerized device further comprises an accelerometer to measure force about an axis of motion, the system being at least partially controllable using the force.

4. The system of claim 2, wherein the computerized device includes a gyroscope, the system being at least partially controllable using the gyroscope.

5. The system of claim 4, wherein the map is displayed on the interface from any panel when the device is rotated as detected by the gyroscope.

6. The system of claim 2, wherein the touchscreen is used to input a command by positioning a detectible object adjacent to an area of the touchscreen displaying interface that relates to the command.

7. The system of claim 6, wherein hot corner commands are accessible from at least part of the interface by positioning the detectable object adjacent to an area of the interface.

8. The system of claim 1, wherein the location is determinable using GPS, WiFi, or cellular networks.

9. The system of claim 1, wherein the panels include screens grouped for a related function, the panels including at least:
a first panel to include the screens for accessing and using the data relating to friends, the friends being associable with the user through the first panel;
a second panel to include the screens for accessing and using the data relating to the clusters, the clusters being definable, viewable, and joinable by the user through the second panel;
a third panel to include the screens for accessing and using deals and events, the events being definable, viewable, and joinable through the third panel; and
a fourth panel to include screens for communicating with the friends, members of the clusters, and other users.

10. The system of claim 9, wherein the deals are fundable using points.

11. A networking system operable on a mobile computerized device with a processor and memory comprising:
an interface to display information and receive data;
panels included in the interface relating to the data that is accessible and usable;
a map to display at least part of the data with relation to a geographic location; and
a location module to determine a present geographic location, the present geographic location being usable to affect a location displayed on the map and the data provided through the panels;
wherein data is receivable and transmittable with additional computerized devices over a network using a network controller;
wherein receipt and transmission of data is conformable to occur within a cluster of users;
wherein an interaction between users is includable in the data;
wherein the mobile computerized device includes a touchscreen, the system being at least partially controllable using the touchscreen by positioning a detectible object adjacent to an area of the touchscreen displaying the interface that relates to a command;
wherein the mobile computerized device includes an accelerometer to measure force about an axis of motion, the system being at least partially controllable using the force measured by the accelerometer;
wherein the computerized device includes a gyroscope to measure rotation, the system being at least partially controllable using the rotation measured by the gyroscope;
wherein the map is displayed on the interface from any panel when the device is rotated as detected by the gyroscope.

12. The system of claim 11, wherein the data accessible from the panels are presented using screens, the screens being accessible through the panel and usable to access or modify that data.

13. The system of claim 11, wherein the data is storable on a database.

14. The system of claim 11, wherein hot corner commands are accessible from the interface by positioning the detectable object adjacent to an area of the interface.

15. The system of claim 11, wherein the location is determinable using GPS, WiFi, or cellular networks.

16. The system of claim 11, wherein the panels include screens grouped for a related function, the panels including at least:
a first panel to include the screens for accessing and using the data relating to friends, the friends being associable with the user through the first panel;
a second panel to include the screens for accessing and using the data relating to clusters, the clusters being definable, viewable, and joinable by the user through the second panel;
a third panel to include the screens for accessing and using deals and events, the events being definable, viewable, and joinable through the third panel; and
a fourth panel to include screens for communicating with the friends, members of the clusters, and other users.

17. The system of claim 16, wherein the deals are fundable using points.

18. A method of providing a networking system using a computerized device with a processor and memory, the system comprising an interface, panels accessible from the interface, screens accessible from the panels, a map, and a location module; the method comprising the steps of:
(a) using the interface to display information and receive data, the data being storable in a database;
(b) providing the panels for accessing and using the data through the screens;
(c) providing the map to display at least part of the data with relation to a geographic location;
(d) using the location module to determine a present geographic location to affect a location that is displayed on the map and the data provided through the panels; and
(e) receiving and transmitting data with additional computerized devices over a network using a network controller;
wherein receipt and transmission of data is conformable to occur within a cluster of users;
wherein an interaction between users is includable in the data.

19. The method of claim 18, wherein the computerized device is a mobile device with a touchscreen, the method further comprising the step of:
(f) receiving inputs from the touchscreen to at least partially control the system.

20. The method of claim 19, wherein the computerized device further comprises an accelerometer to measure force about an axis of motion, the method further comprising the step of:
(g) at least partially controlling the system using the forces.

21. The method of claim 19, wherein the computerized device includes a gyroscope, the method further comprising the step of:
(h) at least partially controlling the system using the gyroscope.

22. The method of claim 21, further comprising the step of:
(i) displaying the map on the interface from any panel when the device is rotated as detected by the gyroscope.

23. The method of claim 18, wherein the touchscreen is used to input a command by positioning a detectible object adjacent to an area of the touchscreen displaying interface that relates to the command.

24. The method of claim 23, wherein hot corner commands are accessible from the interface by positioning the detectable object adjacent to an area of the interface.

25. The method of claim 18, further comprising the step of:
(j) determining the location using GPS, WiFi, or cellular networks.

26. The method of claim 18, further comprising the step of:
(k) grouping the panels for a related function, the panels including at least:
a first panel to include the screens for accessing and using the data relating to friends, the first being associable with the user through the friends panel;
a second panel to include the screens for accessing and using the data relating to clusters, the clusters being definable, viewable, and joinable by the user through the second panel;
a third panel to include the screens for accessing and using deals and events, the events being definable, viewable, and joinable through the third panel; and
a fourth panel to include screens for communicating with the friends, members of the clusters, and other users.

27. The system of claim 26, wherein the deals are fundable using points.
